(19) United States
(12) Patent Application Publication
(10) Pub. No.: US 2026/0352793 A1
(43) Pub. Date: Nov. 5, 2026

(54) SYSTEMS AND METHODS OF DEPTH ESTIMATION WITH MONO-STEREO SWITCHING

(71) Applicant: QUALCOMM Incorporated, San Diego, CA (US)

(72) Inventor: Jamie Menjay LIN, San Diego, CA (US)

(21) Appl. No.: 19/336,067

(22) Filed: Sep. 22, 2025

Related U.S. Application Data
(60) Provisional application No. 63/768,293, filed on Mar. 7, 2025.

(51) Int. Cl. H04N 13/289; H04N 13/00; H04N 13/194; H04N 13/271

(52) U.S. Cl. CPC H04N 13/289; H04N 13/194; H04N 13/271; H04N 2013/0081

(57) ABSTRACT

A device includes a memory configured to store image data associated with a scene and one or more processors coupled to the memory. The one or more processors are configured to obtain the image data based on one or more image capture operations of one or more cameras and to switch between a mono-image depth estimator and a stereo-image depth estimator based on one or more criteria associated with the image data.

### I. CROSS-REFERENCE TO RELATED APPLICATIONS

The present application claims priority from the commonly owned U.S. Provisional Patent Application No. 63/768,293, filed Mar. 7, 2025, the content of which is incorporated herein by reference in its entirety.

### II. FIELD

The present disclosure is generally related to mono-image depth estimation and stereo-image depth estimation.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

These devices may leverage machine learning (ML) models and artificial intelligence (AI) models to enable a wide variety of functionality. For example, such models have been used to process images to estimate depth information from a scene depicted in the image, and conventionally use mono-image depth estimation techniques or stereo-image depth estimation techniques.

Mono-image (or monocular) depth estimation conventionally involves using a single camera and estimating the depth of each pixel in an image, creating a depth map that represents the distance of objects from the camera. This technique typically relies on machine learning models trained on large datasets to infer depth from visual cues like texture, shading, and perspective. A main advantage of monocular depth estimation is its simplicity and cost-effectiveness, as it requires only one camera. However, it can struggle with accuracy and depth perception in complex scenes compared to stereo depth estimation, which uses two cameras to triangulate distances more precisely. Stereo depth estimation provides more reliable depth information but at the cost of increased hardware complexity and expense.

Stereo-image depth estimation conventionally uses two cameras placed at a fixed distance apart to mimic human binocular vision, allowing for the calculation of depth by comparing the disparity between corresponding points in the two images. This technique typically involves capturing two slightly different views of the same scene, rectifying the images, and then using algorithms like block matching to determine the depth information. A main advantage of stereo depth estimation is its accuracy and reliability in providing detailed depth maps, especially in well-lit environments. However, it relies on precise calibration and can be more expensive and complex compared to monocular depth estimation, which uses a single camera and relies on machine learning to infer depth from visual cues.

### IV. SUMMARY

According to one implementation of the present disclosure, a device includes a memory configured to store image data associated with a scene. The device also includes one or more processors coupled to the memory. The one or more processors are configured to obtain the image data based on one or more image capture operations of one or more cameras. The one or more processors are also configured to switch between a mono-image depth estimator and a stereo-image depth estimator based on one or more criteria associated with the image data.

According to another implementation of the present disclosure, a method includes obtaining, at one or more processors, image data based on one or more image capture operations of one or more cameras, the image data associated with a scene. The method also includes switching, at the one or more processors, between a mono-image depth estimator and a stereo-image depth estimator based on one or more criteria associated with the image data.

According to another implementation of the present disclosure, a non-transitory computer readable storage medium stores instructions that, when executed by one or more processors, cause the one or more processors to obtain image data based on one or more image capture operations of one or more cameras, the image data associated with a scene. The instructions, when executed by one or more processors, also cause the one or more processors to switch between a mono-image depth estimator and a stereo-image depth estimator based on one or more criteria associated with the image data.

According to another implementation of the present disclosure, an apparatus includes means for obtaining image data based on one or more image capture operations of one or more cameras, the image data associated with a scene. The apparatus also includes means for switching between a mono-image depth estimator and a stereo-image depth estimator based on one or more criteria associated with the image data.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of an example of a system operable to perform depth estimation with mono-stereo switching, in accordance with one or more aspects of the present disclosure.

FIG. 2 is a block diagram of an example of components operable to perform depth estimation with mono-stereo switching, in accordance with one or more aspects of the present disclosure.

FIG. 3 is a block diagram of an example of components operable to perform depth estimation with mono-stereo switching, in accordance with one or more aspects of the present disclosure.

FIG. 4 is a block diagram of an example of aspects of image data that can be used to select between mono-image depth estimation and stereo-image depth estimation, in accordance with one or more aspects of the present disclosure.

FIGS. 5A, 5B, and 5C are block diagrams of examples of components that can be included in a depth estimation with mono-stereo switching system, in accordance with one or more aspects of the present disclosure.

FIG. 6 is a block diagram of an example of components that can be included in a depth estimation with mono-stereo switching system, in accordance with one or more aspects of the present disclosure.

FIG. 7 is a block diagram of an example of components that can be included in a depth estimation with mono-stereo switching system, in accordance with one or more aspects of the present disclosure.

FIG. 8 is a diagram of an example of an integrated circuit operable to perform depth estimation with mono-stereo switching, in accordance with some examples of the present disclosure.

FIG. 9 is a diagram of a mobile device operable to perform depth estimation with mono-stereo switching, in accordance with some examples of the present disclosure.

FIG. 10 is a diagram of a headset, such as a virtual reality, mixed reality, or augmented reality headset, operable to perform depth estimation with mono-stereo switching, in accordance with some examples of the present disclosure.

FIG. 11 is a diagram of a wearable electronic device operable to perform depth estimation with mono-stereo switching, in accordance with some examples of the present disclosure.

FIG. 12 is a diagram of a voice-controlled speaker system operable to perform depth estimation with mono-stereo switching, in accordance with some examples of the present disclosure.

FIG. 13 is a diagram of a camera operable to perform depth estimation with mono-stereo switching, in accordance with some examples of the present disclosure.

FIG. 14 is a diagram of a vehicle operable to perform depth estimation with mono-stereo switching, in accordance with some examples of the present disclosure.

FIG. 15 is a diagram of an example of a method of performing depth estimation with mono-stereo switching, in accordance with some aspects of the present disclosure.

FIG. 16 is a block diagram of an illustrative example of a device that is operable to perform depth estimation with mono-stereo switching, in accordance with one or more aspects of the present disclosure.

### VI. DETAILED DESCRIPTION

The present disclosure provides systems, apparatus, methods, and computer-readable media for performing depth estimation with mono-stereo switching. Conventional depth estimation systems typically use mono-image depth estimation or stereo-image depth estimation. However, because mono-image depth estimation and stereo-image depth estimation each present a different combination of strengths and drawbacks, selection of either mono-image depth estimation or stereo-image depth estimation inherently includes adopting the particular drawbacks of the selected technique while also forfeiting the particular strengths of the non-selected technique.

Aspects disclosed herein enable a system to leverage the advantages of both mono-image depth estimation and stereo-image depth estimation by selecting mono-image depth estimation or stereo-image depth estimation for each received set of image frames in order to enhance prediction quality (e.g., accuracy, consistency, and stability) and to also enhance system efficiency (e.g., power and latency) over time.

In some aspects disclosed herein, a device includes a mono-image depth estimator, a stereo-image depth estimator, and a dynamic switch configured to switch between mono-image depth estimation and stereo-image depth estimation for each received set of image data from a stream of camera inputs. In an example, the dynamic switch includes a mono-stereo classifier configured to make binary decisions between mono-image depth estimation and stereo-image depth estimation, and a mono-stereo router that is responsive to the mono-stereo classifier and configured to output image data to a selected one of the mono-image depth estimator or the stereo-image depth estimator. In an example, the device includes a buffer that holds depth predictions for a history of one or more previously processed sets of image data, and an optional filter or running-statistics calculator that generates data to assist with selecting between mono-image and stereo-image depth estimation. The device may also include other components associated with image sensing, acquisition, and depth estimation.

According to some aspects, the device uses a pre-determined schedule for mono-stereo switching to make switching decisions over a time sequence of image frames. In some examples, the device can adjust the schedule based on feedback data associated with processing the time sequence of image frames, such as one or more accuracy or efficiency metrics.

According to some aspects, the device switches based on a per-frame mono-stereo classification. In an example, a mono-stereo classifier makes a binary decision between mono-image depth estimation and stereo-image depth estimation for each new time frame of inference (e.g., for each new image frame received in a sequence of image frames). The decision may be based on one or more criteria associated with various aspects, such as the content in a new image frame, depth estimations for one or more recently processed image frames, other feedback data associated with processing the sequence of image frames, or a combination thereof.

According to some aspects, the mono-stereo classifier perform classification based on several factors, such scene change, scene complexity, object change or complexity, background change or complexity, object movement, camera movements, scene lighting, object lighting, background lighting, light contrast (e.g., dynamic-range contrast) of one or more of the scene, object, or background, motion contrast, etc. In some aspects, the classifier performs the classification further based on one or more other aspects such as depth predictions, confidence metrics, likelihood metrics, or a combination thereof, from a previous frame.

According to some aspects, a previous prediction of a depth map from a previous frame (and in some examples, one or more other metrics, such as confidence metrics and/or likelihood metrics) is optionally input to a selected depth estimator along with current image frame data for joint prediction. An inference operation at a depth estimator that includes using the previous prediction(s) can improve the accuracy, reduce the latency, or both, for the current frame data and is referred to herein as a “warm start” inference. Under some circumstances, the device can select to perform a “cold start” inference in which no previous prediction is included in the input for depth estimation of new image frame data, which can avoid, or stop, potential error propagation from a previous time frame.

Because mono-image depth estimation typically consumes less power and has lower latency than stereo-image depth estimation, and because stereo-image depth estimation typically outperforms mono-image depth estimation in accuracy, the disclosed techniques can compare one or more running statistics against targets of accuracy and of efficiency to suitably adjust the static or dynamic schedule/switching.

Particular implementations of the subject matter described in this disclosure can be implemented to realize one or more of the following potential advantages. In some aspects, a technical advantage provided by the disclosed techniques is that the selective use of stereo-image depth estimation for some input frames improves overall accuracy of depth estimation as compared to conventional mono-image depth estimation systems, and also the selective use of mono-image depth estimation for other input frames improves overall efficiency as compared to conventional stereo-image depth estimation systems. In some aspects, a technical advantage of basing the mono-stereo switching decision on one or more aspects of a scene represented in received image data, or on one or more aspects associated with a history of one or more recent depth estimations, or any combination thereof, provides improved accuracy, efficiency, or both, as compared to static switching according to a predetermined schedule.

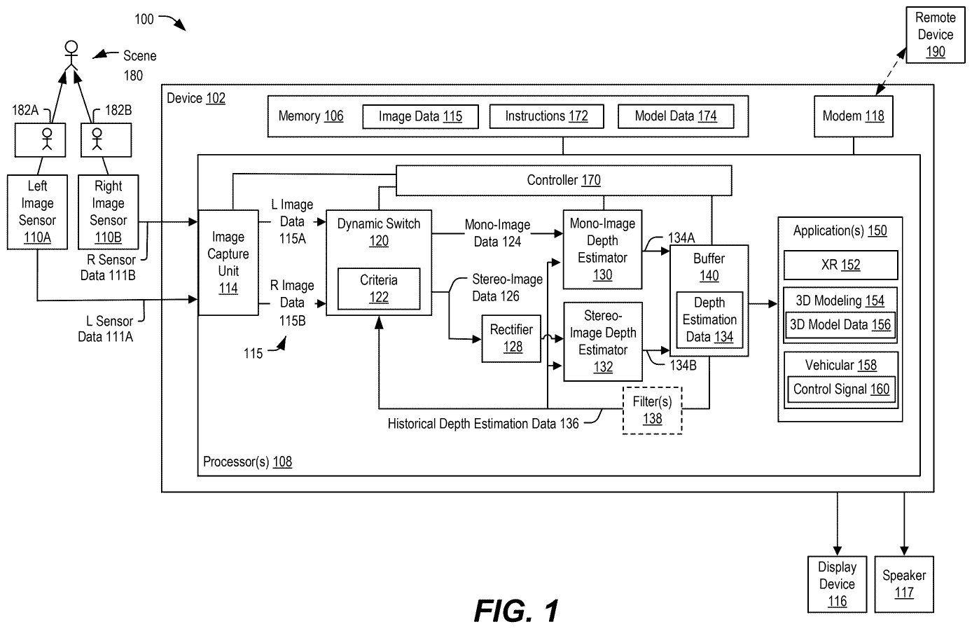

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 operable to perform depth estimation with mono-stereo switching, in accordance with one or more aspects of the present disclosure. The system 100 includes a device 102 that is operable to perform switching between a mono-image depth estimator 130 and a stereo-image depth estimator 132 to generate depth estimation data 134 based on image data 115. The system 100 optionally includes a remote device 190 such that, in some examples, the system 100 includes the remote device 190 and in other examples, the remote device 190 is not included in the system 100. Although described as a remote device, in some other embodiments, the remote device 190 may instead be geographically co-located with the device 102.

The device 102 includes a memory 106, one or more processors 108 (collectively referred to herein as the “processor 108”), and a modem 118. The memory 106 may include one or more memories, such as a single memory or multiple different memories (of the same type or of different types). The memory 106 is configured to store instructions 172 and model data 174. The model data 174 includes or indicates one or more parameters, one or more hyperparameters, configuration data, other data, or a combination thereof, associated with a trained model that is implemented by the device 102, such as the mono-image depth estimator 130, the stereo-image depth estimator 132, or both. In some examples, the instructions 172, when executed by the processor 108, cause the processor 108 to perform one or more operations described herein. In some examples, the memory 106 stores other data, such as thresholds, criterion(s), image data, video data, extended reality data, applications, or a combination thereof.

The memory 106 is configured to store image data 115 associated with a scene 180. For example, a first image sensor 110A (e.g., a left (L) image sensor 110 of a stereo pair) captures a first image 182A of the scene 180 and provides left sensor data 111A to the processor 108. A second image sensor 110B (e.g., a right (R) image sensor 110 of the stereo pair) captures a second image 182B of the scene 180 and provides right sensor data 111B to the processor 108. A separation between the image sensors 110 causes features of the scene 180 to appear in different positions in the two images 182 due to the different perspectives of the image sensors 110. The difference in horizontal position in the two images 182 for an object in the scene 180, referred to as disparity, is larger for objects closer to the image sensors 110 and smaller for objects farther from the image sensors 110. In a particular embodiment, the image sensors 110 are cameras that are coupled to the processor 108 and configured to provide, to the processor 108, the sensor data 111 as stereo camera sensor data corresponding to the image data 115.

The processor 108 includes an image capture unit 114, a dynamic switch 120, a rectifier 128, a mono-image depth estimator 130, a stereo-image depth estimator 132, a buffer 140, one or more applications 150 that are executable by the processor 108, a controller 170, and optionally one or more filters 138. Each of the image capture unit 114, the dynamic switch 120, the rectifier 128, the mono-image depth estimator 130, the stereo-image depth estimator 132, the application 150, the controller 170, the filter 138, or a portion thereof, may be implemented by the processor 108 executing instructions (e.g., software), dedicated hardware (e.g., circuitry), or a combination thereof. In some aspects, the processor 108 is coupled to one or more image sources (not shown). In some embodiments, the image source(s) provide image data to the processor 108, and can be external to or internal to the device 102. For example, the image source(s) can include the image sensors 110, and the processor 108 can receive the sensor data 111 from the image sensors 110. In another example, the image source(s) can include input files (e.g., media data) stored in the memory 106 of the device 102, from a game engine, or from an extended reality (XR) engine (e.g., a virtual reality (VR) engine, an augmented reality (AR) engine, or a mixed reality (MR) engine). As another example, the image source(s) can include the remote device 190, and the modem 118 can be configured to receive the image data 115 from the remote device 190 and to provide the image data 115 to the processor 108.

According to an aspect, the controller 170 is configured to control scheduling, timing, and data flow for operations associated with generating the depth estimation data 134. In an example, the controller 170 generates control signals to affect operations at the image capture unit 114, the dynamic switch 120, the rectifier 128, the mono-image depth estimator 130, the stereo-image depth estimator 132, the buffer 140, the filter 138, or any combination thereof.

The image capture unit 114 is configured to obtain the image data 115 based on one or more image capture operations of the image sensors 110. In an example, the image capture unit 114 is configured to provide control signals associated with image capture parameters to the image sensors 110, such as exposure time, frame rate, resolution, shutter speed, aperture, light sensitivity, etc. The image capture unit 114 receives the left sensor data 111A and the right sensor data 111B as a pair of stereo image frames in a time sequence of image frames, optionally performs pre-processing on one or both of the left sensor data 111A and the right sensor data 111B, and outputs the left image data 115A and the right image data 115B.

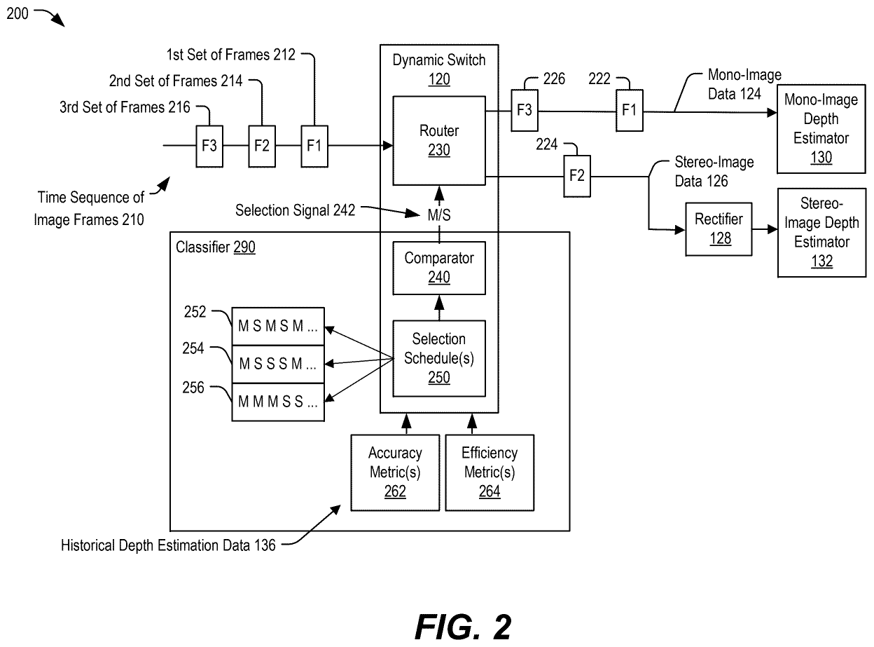

In some cases, the left image data 115A matches the left sensor data 111A; in other cases, the left image data 115A differs from the left sensor data 111A due to processing performed by the image capture unit 114. Similarly, in some cases, the right image data 115B matches the right sensor data 111B; in other cases, the right image data 115B differs from the right sensor data 111B due to processing performed by the image capture unit 114. In a particular embodiment, the image data 115 is included as a set of stereo image frames in a time sequence of image frames from the image sensors 110, such as described further with reference to FIG. 2.

The dynamic switch 120 is configured to receive the image data 115 and to switch between the mono-image depth estimator 130 and the stereo-image depth estimator 132 based on one or more criteria 122 associated with the image data 115. For example, for each set of stereo image frames (e.g., a left image frame in the left image data 115A and a corresponding right image frame in the right image data 115B), the dynamic switch 120 is configured to select one of the mono-image depth estimator 130 or the stereo-image depth estimator 132 based on the one or more criteria 122.

The dynamic switch 120 is configured to route the image data 115 to the selected one of the mono-image depth estimator 130 or the stereo-image depth estimator 132. To illustrate, based on the mono-image depth estimator 130 being selected based on the criteria 122, the dynamic switch 120 routes mono-image data 124 to the mono-image depth estimator 130. In a particular embodiment, the mono-image data 124 corresponds to (e.g., matches) the left image data 115A. In other embodiments, the mono-image data 124 can instead correspond to the right image data 115B. Alternatively, based on the stereo-image depth estimator 132 being selected based on the criteria 122, the dynamic switch 120 routes stereo-image data 126 to the stereo-image depth estimator 132 via the rectifier 128. In a particular embodiment, the stereo-image data 126 corresponds to (e.g., matches) the image data 115 including the left image data 115A and the right image data 115B. The selected one of the mono-image depth estimator 130 or the stereo-image depth estimator 132 is configured to process the image data 115 (e.g., the mono-image data 124 or the stereo-image data 126, respectively) to generate depth estimation data 134 associated with the scene 180.

In some embodiments, the dynamic switch 120 corresponds to, includes, or is included in a classifier that is configured to determine, based on the one or more criteria 122, a classification that indicates a selection of the mono-image depth estimator 130 or the stereo-image depth estimator 132. The classifier is optionally configured to determine the classification based on at least one of an accuracy metric or an efficiency metric that is received as, or included in, historical depth estimation data 136. The historical depth estimation data 136 is associated with one or more previous depth estimates that correspond to one or more prior image frames of the time sequence of image frames. Various examples of classifiers that can be implemented in the processor 108 are described in further detail with reference to FIGS. 2, 3, 5A, 5B, 5C, and 7.

In some embodiments, the criteria 122 includes a selection schedule that indicates a sequence of depth estimators to be selected for generation of depth estimates corresponding to successive image frames of the time sequence of image frames, as described in further detail with reference to FIG. 2. In some such embodiments, the dynamic switch 120 is configured to adjust the selection schedule based on at least one of an accuracy metric or an efficiency metric associated with one or more previous depth estimates (e.g., in the historical depth estimation data 136) that correspond to one or more prior image frames of the time sequence of image frames.

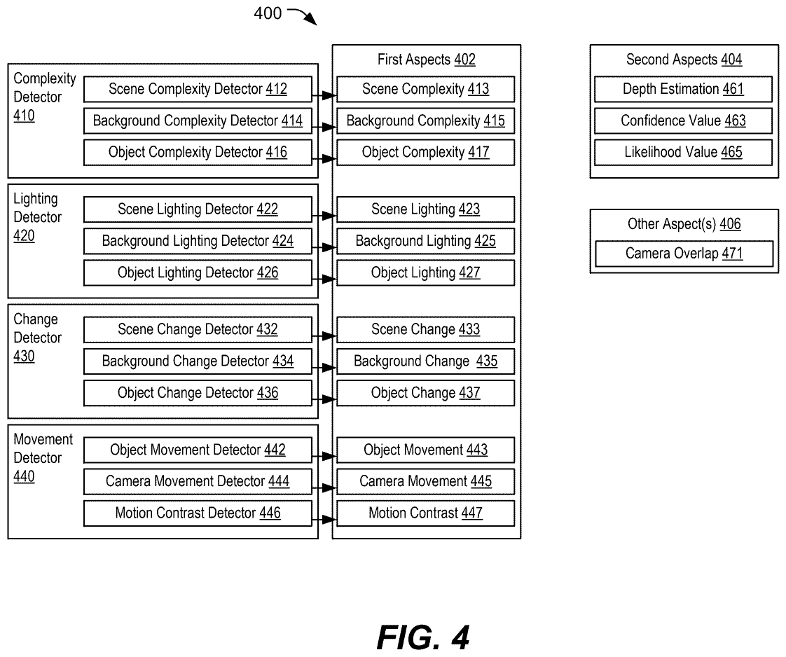

In some embodiments, the criteria 122 are based on one or more first aspects of the image data 115, one or more second aspects of previous image data, or a combination thereof. In an example, the one or more first aspects correspond to a complexity, a lighting, a light contrast, a change, or a combination thereof, of: the scene, an object in the scene, a background of the scene, or a combination thereof. Alternatively, or in addition, the one or more first aspects correspond to an object movement, a camera movement, a motion contrast, or a combination thereof. According to some examples, the one or more second aspects correspond to a depth estimation, a confidence value, a likelihood value, or a combination thereof, associated with the previous image data. An example of various aspects upon which the criteria 122 can be based is provided with reference to FIG. 4.

The mono-image depth estimator 130 is configured to process the mono-image data 124 and generate depth estimation data 134A based on the mono-image data 124. In a particular embodiment, the mono-image depth estimator 130 includes a ML model configured to generate a depth estimate for each pixel in an input image by inferring a depth from visual cues such as texture, shading, and perspective. In an example, the depth estimate for each pixel is at least partially based on a semantic value of the pixel, such as a designation that the pixel is part of a particular object (e.g., “ball” or “person”), which guides the mono-image depth estimator 130 in determining depth estimates for groups of pixels corresponding to particular objects in the mono-image data 124. Optionally, in some embodiments the mono-image depth estimator 130 is further configured to use historical depth estimation data 136 of a prior image as an input when performing inference to determine depth estimates for pixels of a subsequent image, referred to herein as “joint prediction” or “warm start,” as described further with reference to FIG. 6.

The depth estimation data 134A generated by the mono-image depth estimator 130 can correspond to or include a depth map. To illustrate, the depth map for a particular image frame received as the mono-image data 124 can include a predicted depth value for each pixel of the particular image frame. In some implementations, the depth estimation data 134A may include additional information, such as one or more confidence values or likelihood values associated with individual pixels, associated with groups of pixels, associated with the depth map as a whole, of a combination thereof. The depth estimation data 134A is stored in the buffer 140 as depth estimation data 134.

The rectifier 128 is configured to rectify the stereo-image data 126 prior to input into the stereo-image depth estimator 132. In a particular example, the rectifier 128 transforms one or both images in a pair of stereo images so that corresponding points lie on the same horizontal line, such as by reprojecting the images onto a common plane so that epipolar lines are parallel and aligned horizontally. In some embodiments, one or both of the image sensors 110 is capable of movement, such as rotation, translation, or both, relative to the other of the image sensors 110. In such embodiments, the rectifier 128 is configured to receive image sensor position data indicating the position, the orientation, or both, of the image sensors 110 that was used during capture of each received pair of stereo images, and to adjust rectification processing based on the image sensor position data. Rectification reduces the computational complexity of depth estimation processing at the stereo-image depth estimator 132. However, in some embodiments, the rectifier 128 can be bypassed (or omitted from the device 102), and the stereo-image depth estimator 132 may instead be configured to perform depth estimation on non-rectified stereo-image data 126.

The stereo-image depth estimator 132 is configured to receive the rectified stereo-image data 126 (or in some embodiments, non-rectified stereo-image data 126) and to process the stereo-image data 126 to generate depth estimation data 134B. In a particular embodiment, the stereo-image depth estimator 132 includes a ML model configured to generate a depth estimate for each pixel in an “anchor” image of a pair of input images based on one or more techniques such as block matching to identify, for each pixel in one of the input images, a corresponding pixel in the other of the input images, from which a disparity value (e.g., a horizontal pixel offset for a common point in both images) for each of the pixels is estimated. The estimated disparity values can be used, in conjunction with position data, orientation data, or both, of the image sensors 110, to compute depth values, such as via triangulation. In an example, the depth for each pixel can be determined as: depth=f*B/d, where f represents the focal length of the camera, B represents the baseline (e.g., the distance between the image sensors 110), d represents the disparity value for the pixel, “*” represents a multiplication operator, and “/” represents a division operator. Optionally, in some embodiments the stereo-image depth estimator 132 is further configured to use historical depth estimation data 136 of a prior image as an input when performing inference to determine depth estimates for pixels of a subsequent set of stereo images, referred to herein as “joint prediction” or “warm start,” as described further with reference to FIG. 6.

The depth estimation data 134B generated by the mono-image depth estimator 130 can correspond to or include a disparity map or, optionally, a depth map. To illustrate, the disparity map for a particular pair of stereo-image frames received as the stereo-image data 126 can include a predicted disparity value for each pixel of a particular image frame of the pair of stereo-image frames. In some implementations, the depth estimation data 134B may include additional information, such as one or more confidence values or likelihood values associated with individual pixels, associated with groups of pixels, associated with the disparity map as a whole, of a combination thereof. The depth estimation data 134B is stored in the buffer 140 as depth estimation data 134.

The buffer 140 configured to receive depth estimation data 134 for one set of image frames of the image data 115 and store the depth estimation data 134 as (or as part of) historical depth estimation data 136 that is associated with at least one sequentially prior set of the image data 115 for processing one or more subsequent sets of image frames of the image data 115. In a particular embodiment, the buffer 140 is configured as a ring buffer that is sized to store a particular number (e.g., one, two, three, etc.) of most recently generated sets of depth estimation data 134 and, when fully occupied, to overwrite the oldest buffered set of depth estimation data 134 as new sets of depth estimation data 134 are received. Although the buffer 140 is depicted in the processor 108, in some embodiments, the buffer 140 is included in the memory 106.

The historical depth estimation data 136 can include a depth or disparity map associated with a set of stereo-image frames of the image data 115. For example, a depth map generated by the mono-image depth estimator 130 can include a depth value for each pixel of the mono-image data 124 associated with the set of stereo-image frames, and optionally can include color values (e.g., RGB) of each pixel, semantic data for each pixel, one or more other types of data associated with each pixel, or a combination thereof. As another example, a disparity map generated by the stereo-image depth estimator 132 may be converted into a depth map prior to use as the historical depth estimation data 136. In some embodiments, disparity values (if any) in the depth estimation data 134 are converted to depth values prior to being stored into the buffer 140, while stored in the buffer 140, or after retrieval from the buffer 140 for processing as the historical depth estimation data 136. For simplicity of explanation, “depth” and “disparity” are used interchangeably in the description that follows.

In some implementations that include the optional filter 138, the historical depth estimation data 136 may additionally, or alternatively, include data generated by the filter 138. In some examples, the filter 138 processes the historical depth estimation data 136 to generate a running average of pixel depth values, such as to stabilize (e.g., reduce jitter) of historical depth predictions over sequential sets of images of the scene 180. In some examples, the filter 138 is configured to generate one or more sets of running statistics associated with the depth data, efficiency metrics, accuracy metrics, etc., which can be included in the historical depth estimation data 136.

In a particular embodiment, the historical depth estimation data 136 includes an accuracy metric that indicates an accuracy of predicted depth values in the historical depth estimation data 136. For example, an accuracy metric may be based on one or more confidence values generated in conjunction with generating the predicted depth values, based on detection of one or more errors revealed in later sets of the image data 115 (such as occlusion of a first object by a second object that was previously predicted to be more distant than the first object, or mispredicted depth predictions that are revealed due to movement of the device 102 relative to the scene 180, as non-limiting examples), based on one or more other factors, or any combination thereof.

In a particular embodiment, the historical depth estimation data 136 includes one or more efficiency metric, such as a ratio of an accuracy of predicted depth values as compared to a cost (e.g. in computational complexity, power consumption, latency, etc.) associated with achieving that accuracy. For example, because the stereo-image depth estimator 132 generally produces higher accuracy depth estimates than the mono-image depth estimator 130, but the mono-image depth estimator 130 generates depth estimates using less computational complexity and with lower power consumption than the stereo-image depth estimator 132, selection between the mono-image depth estimator 130 and the stereo-image depth estimator 132 can be at least partially based on reducing or minimizing usage of the stereo-image depth estimator 132 while ensuring that a threshold accuracy of depth estimation remains satisfied. In some implementations, the historical depth estimation data 136 includes efficiency metrics for each of the mono-image depth estimator 130 and the stereo-image depth estimator 132 to enable selection, at the dynamic switch 120, based on a comparison of the recent historical performance of the mono-image depth estimator 130 and the stereo-image depth estimator 132.

In some embodiments, the processor 108 (e.g., the controller 170) is configured to provide the historical depth estimation data 136, along with the mono-image data 124 from the image data 115, as inputs to the mono-image depth estimator 130. For example, the processor 108 can be configured to select whether to: perform joint depth estimation prediction at the mono-image depth estimator 130 based on the image data 115 (e.g., the mono-image data 124) and the historical depth estimation data 136; or perform depth estimation prediction based on the image data 115 without the historical depth estimation data 136. Similarly, in some embodiments, the processor 108 (e.g., the controller 170) is configured to provide the historical depth estimation data 136, along with the stereo-image data 126 from the image data 115, as inputs to the stereo-image depth estimator 132. For example, the processor 108 can be configured to select whether to: perform joint depth estimation prediction at the stereo-image depth estimator 132 based on the image data 115 (e.g., the stereo-image data 126) and the historical depth estimation data 136; or perform depth estimation prediction based on the image data 115 without the historical depth estimation data 136. Because errors that have occurred in a prior depth estimation can influence the occurrence of more errors in a current depth estimation during joint estimation prediction, selection between joint depth estimation prediction using the historical depth estimation data 136 and depth estimation prediction without using the historical depth estimation data 136 may be based on an error propagation metric associated with the historical depth estimation data 136, such as described further with reference to FIG. 6.

In some embodiments, the depth estimation data 134 can be used by the processor 108 during execution of one or more of the applications 150. In the illustrated embodiment, the applications 150 can include an extended reality (XR) application 152 (e.g., a virtual reality (VR), augmented reality (AR), or mixed reality (MR) application), a 3D modeling application 154, a vehicular application 158, or a combination thereof. Although the applications 150 are depicted as including the XR application 152, the 3D modeling application 154, and the vehicular application 158, in other embodiments the applications 150 can omit one or more of the XR application 152, the 3D modeling application 154, or the vehicular application 158; the applications 150 can include one or more other applications that use the depth estimation data 134 instead of, or in addition to, the XR application 152, the 3D modeling application 154, and the vehicular application 158; or any combination thereof.

In a particular embodiment, the XR application 152 is executable by the processor 108 to generate display data associated with the image data 115, such as one or more computer-generated objects or text that is integrated into or overlaid onto the scene 180. For example, the XR application 152 can correspond to an AR application that is configured to insert a virtual object at a particular depth in the scene 180 by using the depth estimation data 134 to determine which pixels of the scene 180 are to be occluded by the object and which pixels are not, and generate output display data that represents the virtual object inserted in the scene for display at a display device 116.

In a particular embodiment, the 3D modeling application 154 is executable by the processor 108 to generate, based on the image data 115 and depth estimation data 134 generated by the mono-image depth estimator 130 or the stereo-image depth estimator 132, 3D model data 156 corresponding to a 3D representation of the scene 180. For example, the 3D modeling application 154 may generate a 3D model of the scene 180, which may be used to generate various views of the scene 180 from different viewpoints, which may be used in conjunction with one or more applications such as the XR application 152 or the vehicular application 158.

In a particular embodiment, the vehicular application 158 is executable by the processor 108 to generate, based on the image data 115 and depth estimation data 134 generated by the mono-image depth estimator 130 or the stereo-image depth estimator 132, one or more control signals 160 to control operation of a vehicle. For example, the device 102 (e.g., the processor 108 and the image sensors 110) may be included in a vehicle, such as an automobile, and the depth estimation data 134 may be used in detecting approximate locations of elements in the vicinity of the vehicle, such as other vehicles, pedestrians, or road hazards. To illustrate, the vehicular application 158 may be used as part of, or in conjunction with, an autonomous control system or a driver assistance system for the vehicle, such as a collision avoidance system.

The modem 118 is coupled to the processor 108 and is configured to transmit data, such as the depth estimation data 134, the 3D model data 156, or the control signal 160, to a second device, such as via a wireless transmission to the remote device 190 (e.g., a remote server). Additionally, or alternatively, the modem 118 is configured to transmit other data, such as image data, video data, audio data, or a combination thereof, to the remote device 190. In some embodiments, the modem 118 may be configured to receive data from another device, such as the remote device 190 (e.g., a remote server or user device). For example, the data received by the modem 118 may include the sensor data 111, the image data 115, the model data 174, media data (e.g., image data, video data, or audio data), other input(s), or a combination thereof.

The processor 108 is also coupled to the display device 116 and a speaker 117. The display device 116 is coupled to the processor 108 and is configured to output one or more displayable outputs to a user of the device 102. The displayable output(s) may include the image data 115 representing the image, XR display data generated by the XR application 152, one or more representations of the scene 180 based on the 3D model data 156, an alert or instruction for an operator of a vehicle and corresponding to the control signal 160, or a combination thereof. In a particular example, the display device 116 is configured to receive and display output data that is generated based on the model data 156 and that corresponds to a view of the 3D representation of the scene 180. In some examples, the display device 116 includes a display screen, a monitor or television, a projector, or a combination thereof. In some embodiments, the processor 108 and the display device 116 are included in an extended reality headset, and the display device 116 presents visual output generated by the XR application 152. In some embodiments, the one or more processors 108 and the display device 116 are included in a laptop computer device, a mobile device, or a wearable device, and the display device 116 presents a view generated by the 3D modeling application 154. The speaker 117 is coupled to the processor 108 and is configured to output one or more audio outputs. For example, the speaker 117 may output audio that corresponds to media data stored at the memory 106 or received from another device, audio that corresponds to media data that includes the image data 115, other audio, or a combination thereof.

The image sensors 110, the display device 116, the speaker 117, or a combination thereof may be coupled to or integrated within the device 102. Although the device 102 is described as being coupled to or including the image sensors 110, the display device 116, the speaker 117, and the modem 118, in other implementations the device 102 may not include or be coupled to the image sensors 110, the display device 116, the speaker 117, the modem 118, or a combination thereof. As such, any of the image sensors 110, the display device 116, the speaker 117, or the modem 118 may be optional and, in embodiments in which such component(s) are not included in or coupled to the device 102, the corresponding data may be received from, or transmitted to, another device, such as the remote device 190.

In a particular embodiment, during operation of the system 100, the processor 108 obtains, at the image capture unit 114, the sensor data 111 from the image sensors 110. For example, the sensor data 111 can include a pair of stereo image frames that correspond to the images 182A and 182B of the scene 180 and that are concurrently captured by the left image sensor 110A and the right image sensor 110B. (As used herein, two events or operations are “concurrent” when one of the events or operations is initiated at the same time as the initiation of the other event or operation (e.g., the two events or operations are simultaneous in time), or when one of the events or operations is initiated after the initiation of, but before the termination of, the other event or operation (e.g., the two events or operations are at least partially overlapping in time). The left image data 115A and the right image data 115B are input to the dynamic switch 120, and the dynamic switch 120 selects, based on the criteria 122 and optionally further based on the historical depth estimation data 136, whether to perform depth estimation for the image data 115 at the mono-image depth estimator 130 or at the stereo-image depth estimator 132.

Based on the dynamic switch 120 selecting the mono-image depth estimator 130, the mono-image data 124 (e.g., the left image data 115A) is input into the mono-image depth estimator 130. Optionally, the controller 170 may also select to perform joint depth estimation prediction, in which case the historical depth estimation data 136 (e.g., a depth map from the most recently processed set of image frames) is also input into the mono-image depth estimator 130. The resulting depth estimation data 134A is stored into the buffer 140, from which the depth estimation data 134A may be accessed for use by one or more of the applications 150, or as historical depth estimation data 136 for processing of a next sequential pair of image frames in the image data 115, or both.

Alternatively, based on the dynamic switch 120 selecting the stereo-image depth estimator 132, the stereo-image data 126 (e.g., the image data 115 after rectification) is input into the stereo-image depth estimator 132. Optionally, the controller 170 may also select to perform joint depth estimation prediction, in which case the historical depth estimation data 136 (e.g., a depth map from the most recently processed set of image frames) is also input into the stereo-image depth estimator 132. The resulting depth estimation data 134B is stored into the buffer 140, from which the depth estimation data 134B may be accessed for use by one or more of the applications 150, or as historical depth estimation data 136 for processing of a next sequential pair of image frames in the image data 115, or both.

Thus, as sequential sets of the image frames captured by the image sensors 110 are received as image data 115 at the dynamic switch 120, the dynamic switch 120 may switch between routing the sets of image frames to the mono-image depth estimator 130 for mono-image depth estimation and routing the sets of image frames to the stereo-image depth estimator 132 for stereo-image depth estimation, based on the one or more criteria 122 and, in some embodiments, based on the historical depth estimation data 136 (e.g., one or more accuracy metric or efficiency metric) associated with one or more sequentially prior sets of image frames.

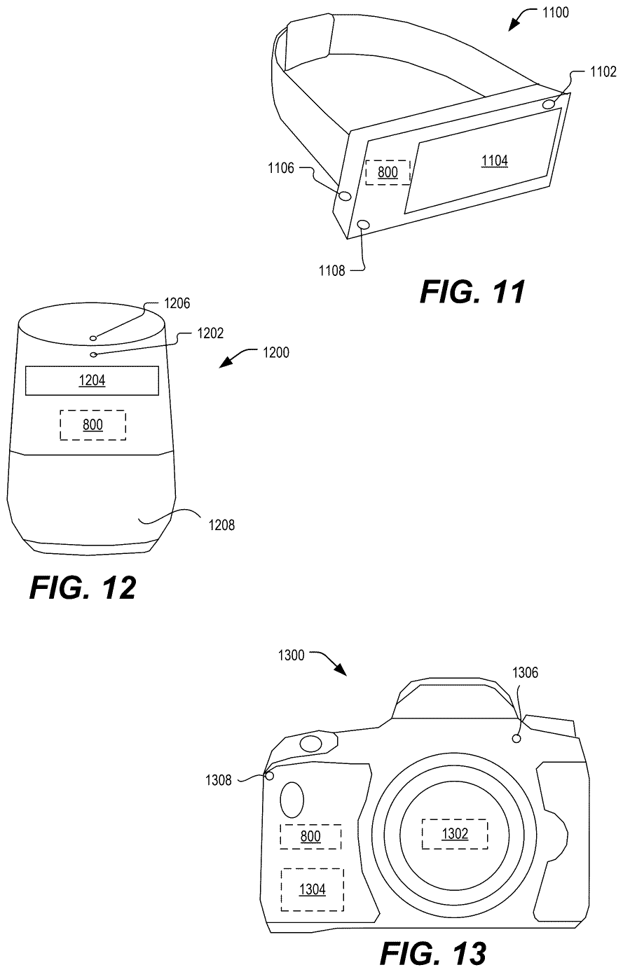

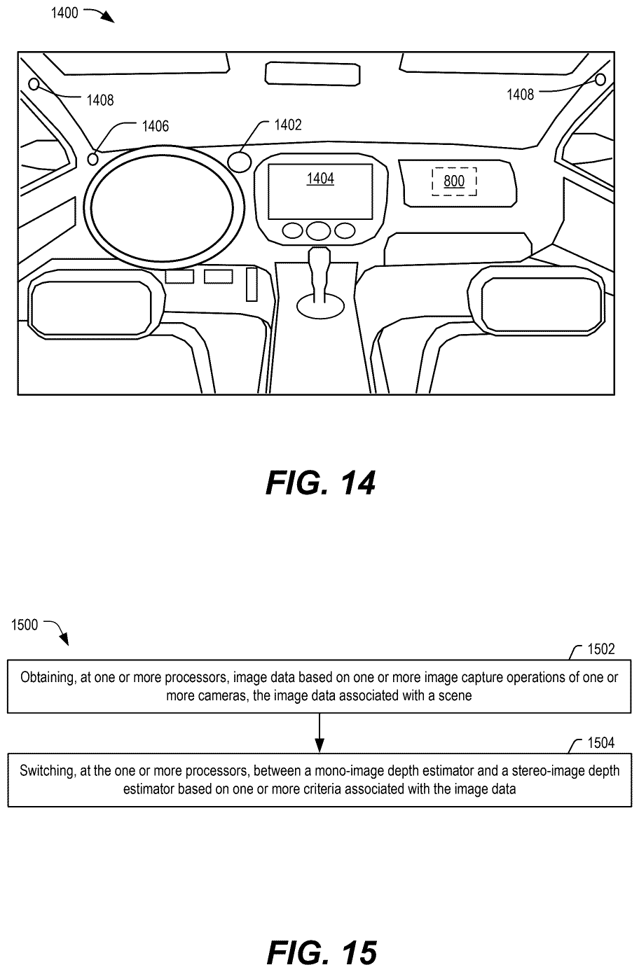

In some examples, the device 102 corresponds to or is included in one of various types of devices, such that the processor 108 can be integrated in multiple types of devices. In an illustrative example, the processor 108 is integrated in a wearable electronic device as depicted in FIG. 11, a virtual reality, mixed reality, or augmented reality headset as depicted in FIG. 10, or another wearable device. In another illustrative example, the processor 108 is integrated in a mobile device (a mobile phone or a tablet) as depicted in FIG. 9, a voice-controlled speaker system as depicted in FIG. 12, a camera as depicted in FIG. 13, a vehicle as depicted in FIG. 14, a computer (e.g., a laptop computer) or a server, or another system or device.

In a particular example, the device 102 includes a memory (e.g., the memory 106) configured to store image data (e.g., the image data 115) associated with a scene (e.g., the scene 180). The device 102 includes one or more processors (e.g., the processor 108) coupled to the memory and configured to obtain the image data based on one or more image capture operations of one or more cameras (e.g., the image sensors 110). The one or more processors are also configured to switch (e.g., at the dynamic switch 120) between a mono-image depth estimator (e.g., the mono-image depth estimator 130) and a stereo-image depth estimator (e.g., the stereo-image depth estimator 132) based on one or more criteria (e.g., the criteria 122) associated with the image data.

One technical advantage of implementing the device 102 as described above is that the selective use of the stereo-image depth estimator 132 for some sets of image data improves overall accuracy as compared to conventional mono-image depth estimation systems, and also the selective use of the mono-image depth estimator 130 for other sets of the image data improves efficiency as compared to conventional stereo-image depth estimation systems. In some aspects, a technical advantage of basing switching decisions of the dynamic switch 120 on the criteria 122 is improved accuracy, efficiency, or both, as compared to performing static switching according to a predetermined schedule.

FIG. 2 is a block diagram of an example of components 200 operable to perform depth estimation with mono-stereo switching, in accordance with one or more aspects of the present disclosure. The components 200 include the rectifier 128, the mono-image depth estimator 130, the stereo-image depth estimator 132, and a schedule-based implementation of the dynamic switch 120 of FIG. 1.

Each of components 200, or portion(s) thereof, may be implemented by a processor (e.g., the processor 108) executing instructions (e.g., software), dedicated hardware (e.g., circuitry), or a combination thereof. Additionally, or alternatively, although illustrated in FIG. 2 as separate components, in other embodiments, one or more of the dynamic switch 120, the rectifier 128, the mono-image depth estimator 130, or the stereo-image depth estimator 132 may be included in or integrated within a single component that is configured to perform the operations described with reference to the respective components.

The dynamic switch 120 includes a router 230, a comparator 240, and one or more selection schedules 250. The router 230 is configured to receive a time sequence of image frames 210, such as from one or more cameras. The time sequence of image frames 210 includes a first set of frames 212, a second set of frames 214 that sequentially follows the first set of frames 212, and a third set of frames 216 that sequentially follows the second set of frames 214. The router 230 is configured to route each of the received sets of frames 212, 214, 216 to one of the mono-image depth estimator 130 or to the stereo-image depth estimator 132 (e.g., via the rectifier 128) based on a selection signal 242 received from the comparator 240.

In a particular embodiment, each of the first set of frames 212, the second set of frames 214, and the third set of frames 216 corresponds to or includes a pair of stereo images frames and corresponds to a respective instance of the image data 115 of FIG. 1. Each of the sets of frames 212, 214, 216 can include data that indicates a position (or a relative position) of the respective set of frames in the time sequence of image frames 210. For example, each of the sets of frames 212, 214, 216 may include a time stamp, sequence number, index, or other position-identifying data.

The comparator 240 is configured to generate a selection signal 242 for each set of frames in the time sequence of image frames 210 based on a selection schedule 250 that indicates a sequence of depth estimators to be selected for generation of depth estimates corresponding to successive image frames of the time sequence of image frames 210. For example, the selection schedule 250 can correspond to a first selection schedule 252 in which a selection of mono-image depth estimation (“M”) or stereo-image depth estimation (“S”) alternates with each received set of frames in the time sequence of image frames 210.

In a particular embodiment, as each new set of frames is received at the dynamic switch 120, the comparator 240 compares a sequential position of the set of frames to a corresponding position in the selection schedule 250 and outputs a respective M or S indicator as the selection signal 242 to the router 230. For example, the selection signal 242 can include a binary indicator that can be set to one of: a first value (e.g., 0) that indicates mono-image depth estimation (e.g., a M indicator), or a second value (e.g., 1) that indicates stereo-image depth estimation (e.g., an S indicator). In a particular example, the selection schedule 250 and the position-identifying data of the frames correspond to, or are part of, the criteria 122 of FIG. 1.

In a particular embodiment, the selection schedule 250 corresponds to a fixed-size list of M and S indicators, and the comparator 240 is configured to compare a sequential position of a set of frames in the time sequence of image frames 210 to position in the list using a modulo operation based on to the size of the list. In an example in which selection schedule 250 is a list of 10 entries, the comparator 240 matches a first received set of frames of the time sequence of image frames 210 to the first entry in the selection schedule 250, a second received set of frames of the time sequence of image frames 210 to the second entry in the selection schedule 250, an 11th received frame of the time sequence of image frames 210 to the first entry (e.g., 11 mod 10=1), a 12th received frame to the second entry (e.g., 12 mod 10=2), etc. In other embodiments, the selection schedule 250 can include, correspond to, or otherwise be based on one or more formulas, heuristics, or algorithms that can be evaluated by the comparator 240 to generate the selection signal 242 instead of, or in addition to, a list of M and S indicators.

In a particular embodiment, the dynamic switch 120 is configured to adjust the selection schedule 250 based on at least one of an accuracy metric or an efficiency metric associated with one or more previous depth estimates that correspond to one or more prior image frames of the time sequence of image frames 210. For example, the dynamic switch 120 may receive one or more accuracy metrics 262, one or more efficiency metrics 264, or both, such as previously described with reference to the historical depth estimation data 136.

In a first illustrative example, the accuracy metric 262 can be compared to a first threshold accuracy (e.g., a minimum accuracy criterion) and, if the accuracy metric 262 indicates that an accuracy of one or more most-recently generated depth estimates (e.g., a moving average) is below the first threshold accuracy, the dynamic switch 120 adjusts the selection schedule 250 to increase a frequency of S selections and decrease a frequency of M selections (e.g., a higher S duty ratio), based on a default assumption that stereo-image depth estimation is typically more accurate than mono-image depth estimation. For example, the dynamic switch 120 can switch from using the first selection schedule 252 that has a 50% duty ratio of S selections to a second selection schedule 254 that has a 60% duty ratio of S selections, such as the selection sequence “M S S S M.”

In a second illustrative example, the accuracy metric 262 can be compared to a second threshold accuracy that is higher than the first threshold accuracy and, if the accuracy metric 262 indicates that an accuracy of one or more most-recently generated depth estimates (e.g., a moving average) exceeds the second threshold accuracy, the accuracy is unnecessarily high and can be lowered to reduce computational load and power consumption without affecting, or without significantly impairing, performance of the applications that use the resulting depth estimation data 134 (e.g., such as the applications 150 of FIG. 1). In this case, the dynamic switch 120 adjusts the selection schedule 250 to decrease the frequency of S selections and increase the frequency of M selections (e.g., a lower S duty ratio), based on a default assumption that a higher efficiency can be achieved by increasing the proportion of M selections. For example, the dynamic switch 120 can switch from using the first selection schedule 252 that has a 50% duty ratio of S selections to a third selection schedule 256 that has a 40% duty ratio of S selections, such as the selection sequence “M M M S S.”

In a third illustrative example, the efficiency metric 264 can indicate an efficiency of recent depth estimations generated by the mono-image depth estimator 130, an efficiency of recent depth estimations generated by the stereo-image depth estimator 132, or both. The efficiency metric 264 can thus indicate when one or both of the mono-image depth estimator 130 or the stereo-image depth estimator 132 are performing with higher or lower than expected accuracy (e.g., due to a particular type of scene for which the mono-image depth estimator 130 is more accurate than usual and/or the stereo-image depth estimator 132 is less accurate than usual, or vice-versa). The dynamic switch 120 can therefore adjust the selection schedule 250 to improve efficiency (e.g., accuracy per unit cost associated with computational load and/or power consumption), increase accuracy, or both.

In a particular embodiment, the comparator 240 operating based on data that indicates a position (or a relative position) of each set of frames in the time sequence of image frames 210 and the selection schedule 250, and optionally in conjunction with processing circuitry of the dynamic switch 120 associated with adjusting the selection schedule 250 based on the accuracy metric 262, the efficiency metric 264, or a combination thereof, functions as a classifier 290. The classifier 290 is configured to classify each incoming set of frames as belonging to a class of frames designated for mono-image depth estimation (M) or belonging to a class of frames designated for stereo-image depth estimation(S).

During operation, the dynamic switch 120 may route the sets of image frames in the time sequence of image frames 210 according to the selection schedule 250 selected as the first selection schedule 252 (e.g., “M S M S M S . . . ”). The first set of frames 212 is identified at the comparator 240 as corresponding to a first element of the first selection schedule 252 (“M”) and outputs an M indication as the selection signal 242. In response to the M indication, the router 230 sends first routed image data 222 to the mono-image depth estimator 130. In some embodiments, the first routed image data 222 can correspond to one of the two frames of the first set of frames 212 (e.g., the left stereo image frame). In other embodiments the first routed image data 222 can include both frames of the first set of frames 212, and the mono-image depth estimator 130 may perform depth processing on one of the frames and discard the other frame of the first set of frames 212.

The second set of frames 214 is identified at the comparator 240 as corresponding to a second element of the first selection schedule 252 (“S”), and the comparator 240 outputs an S indication as the selection signal 242. In response to the S indication, the router 230 sends second routed image data 224 (e.g., the second set of frames 214) to the stereo-image depth estimator 132 via the rectifier 128.

The third set of frames 216 is identified at the comparator 240 as corresponding to a third element of the first selection schedule 252 (“M”), and the comparator 240 outputs an M indication as the selection signal 242. In response to the M indication, the router 230 sends third routed image data 226 (e.g., the left stereo image frame of the third set of frames 216) to the mono-image depth estimator 130.

Optionally, the dynamic switch 120 can receive updated values of the accuracy metric 262, the efficiency metric 264, or both, as feedback from processing earlier frames of the time sequence of image frames 210 and may make one or more adjustments to the selection schedule 250 for next sequential frames of the time sequence of image frames 210, such as to increase accuracy above a first threshold, to increase efficiency while allowing accuracy to decrease when the accuracy is above a second threshold, to make adjustments based on one or more values of the efficiency metric 264, or any combination thereof, as illustrative, non-limiting examples.

Although FIG. 2 depicts three sets of frames 212, 214, 216 in the time sequence of image frames 210, it should be understood that the time sequence of image frames 210 may have any number of sets of frames. Although three selection schedules 252, 254, 256 are illustrated, in other embodiments the dynamic switch 120 may support a single selection schedule (e.g., no adjustment is made the selection schedule 250), two selection schedules, or more selection schedules. Although the selection schedules 252, 254, and 256 are illustrated as selectable lists of selection indications, in other embodiments one or more of the selection schedules may be generated on-the-fly as sets of frames are received. Although the dynamic switch 120 is illustrated as receiving the accuracy metric 262 and the efficiency metric 264, in some embodiments the accuracy metric 262, the efficiency metric 264, or both are omitted, one or more other metrics of the historical depth estimation data 136 are received by the dynamic switch 120, or a combination thereof.

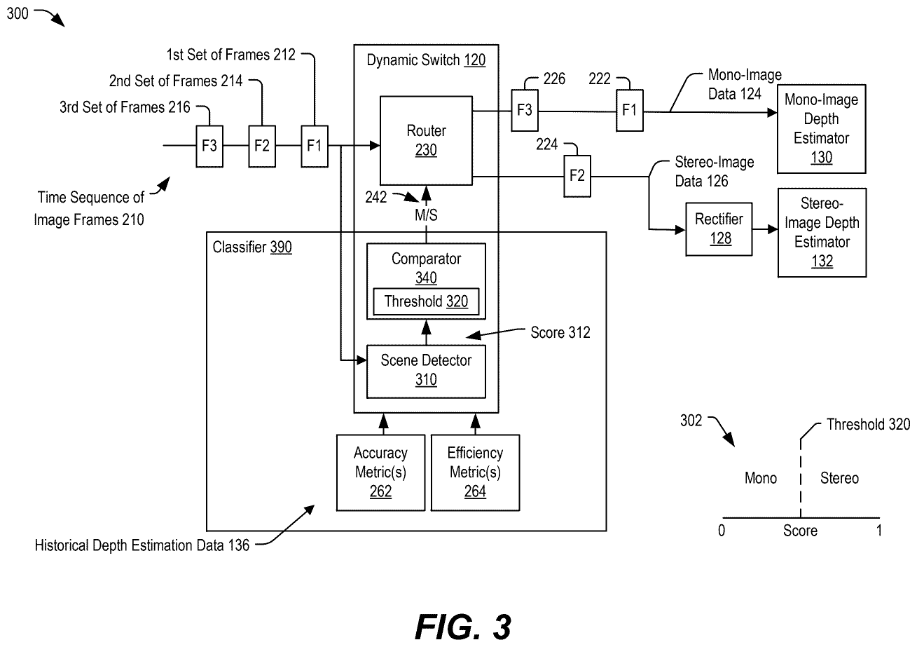

FIG. 3 is a block diagram of an example of components 300 operable to perform depth estimation with mono-stereo switching, in accordance with one or more aspects of the present disclosure. The components 300 include the rectifier 128, the mono-image depth estimator 130, the stereo-image depth estimator 132, and a scene-based implementation of the dynamic switch 120 of FIG. 1. The dynamic switch 120 includes the router 230 of FIG. 2, a scene detector 310, and a comparator 340. The router 230 is configured to route each of the received sets of frames 212, 214, 216 of the time sequence of image frames 210 to one of the mono-image depth estimator 130 or to the stereo-image depth estimator 132 (e.g., via the rectifier 128) based on a selection signal 242 received from the comparator 340.

Each of components 300, or portion(s) thereof, may be implemented by a processor (e.g., the processor 108) executing instructions (e.g., software), dedicated hardware (e.g., circuitry), or a combination thereof. Additionally, or alternatively, although illustrated in FIG. 3 as separate components, in other embodiments, one or more of the dynamic switch 120, the rectifier 128, the mono-image depth estimator 130, or the stereo-image depth estimator 132, the router 230, the comparator 340, or the scene detector 310, may be included in or integrated within a single component that is configured to perform the operations described with reference to the respective components.

The comparator 340 is configured to generate a selection signal 242, e.g., the M or S indicator, for each set of frames in the time sequence of image frames 210 based on a score 312 that is determined by the scene detector 310. In an example, the comparator 340 compares the score 312 to a threshold 320 to determine the selection signal 242. For example, as graphically illustrated in a diagram 302, the score 312 may have any value in the range from 0 to 1, and the threshold 320 may also be set to a value between 0 and 1. In the illustrated example, the comparator 340 selects mono-image depth estimation (the M indicator) for a set of frames when the score 312 is less than or equal to the threshold 320, and selects stereo-image depth estimation (e.g., the S indicator) when the score 312 is greater than the threshold 320.

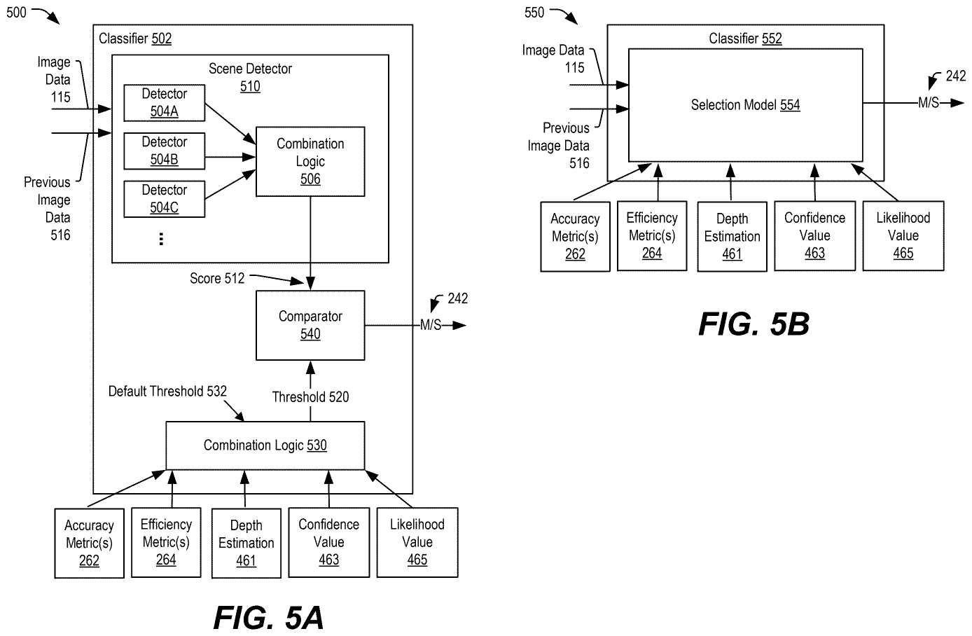

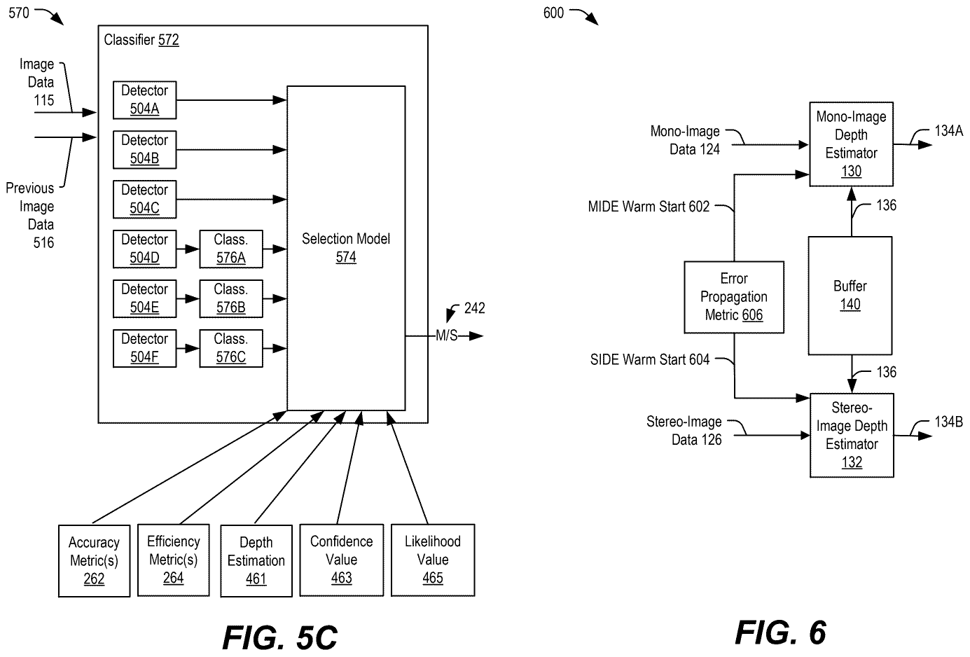

The scene detector 310 is configured to determine the score 312 based on evaluation of one or more aspects of scene content associated with the particular set of frames in the time sequence of image frames 210. In a particular embodiment, higher values of the score 312 indicate higher scene complexity, higher amounts of scene change, one or more other aspects of the scene content, or a combination thereof, for which a higher accuracy depth estimation technique (e.g., the stereo-image depth estimator 132) should be used, while lower values of the score 312 indicate lower scene complexity, lower amounts of scene change, one or more other aspects of the scene content, or a combination thereof, for which a more efficient depth estimation technique (e.g., the mono-image depth estimator 130) may be used. In a particular embodiment, the scene detector 310 is configured to determine the score 312 for a particular set of frames in the time sequence of image frames 210 based on one or more first aspects of the image data of a particular set of frames, one or more second aspects of previous image data of a previous set of frames in the time sequence of image frames 210, or a combination thereof, such as described in further detail with reference to FIGS. 4 and 5A.

In a particular embodiment, as each new set of frames is received at the dynamic switch 120, the scene detector 310 generates a corresponding score 312, and the comparator 340 compares a value of the score 312 to the threshold 320 and outputs a respective M or S indicator as the selection signal 242 to the router 230. In a particular example, scene data of each set of frames in the time sequence of image frames 210, and optionally the accuracy metric 262, the efficiency metric 264, or a combination thereof, correspond to, or are part of, the criteria 122 of FIG. 1.

In a particular embodiment, the dynamic switch 120 is configured to adjust the threshold 320 based on at least one of an accuracy metric or an efficiency metric associated with one or more previous depth estimates that correspond to one or more prior image frames of the time sequence of image frames 210. For example, the dynamic switch 120 may receive the one or more accuracy metrics 262, the one or more efficiency metrics 264, or both.

In a first illustrative example, the accuracy metric 262 can be compared to a first threshold accuracy (e.g., a minimum accuracy criterion) and, if the accuracy metric 262 indicates that an accuracy of one or more most-recently generated depth estimates (e.g., a moving average) is below the first threshold accuracy, the dynamic switch 120 adjusts the threshold 320 to a lower value so that more sets of frames match the criteria for S selections and fewer sets of frames match the criteria for M selections, based on a default assumption that stereo-image depth estimation is typically more accurate than mono-image depth estimation.

In a second illustrative example, the accuracy metric 262 can be compared to a second threshold accuracy that is higher than the first threshold accuracy and, if the accuracy metric 262 indicates that an accuracy of one or more most-recently generated depth estimates (e.g., a moving average) exceeds the second threshold accuracy, the accuracy is unnecessarily high and can be lowered to reduce computational load and power consumption without affecting, or without significantly impairing, performance of the applications that use the resulting depth estimation data 134 (e.g., such as the applications 150 of FIG. 1). In this case, the dynamic switch 120 adjusts the threshold 320 to a higher value so that fewer sets of frames match the criteria for S selections and more sets of frames match the criteria for M selections, based on a default assumption that a higher efficiency can be achieved by increasing the proportion of M selections.

In a third illustrative example, the efficiency metric 264 can indicate an efficiency of recent depth estimations generated by the mono-image depth estimator 130, an efficiency of recent depth estimations generated by the stereo-image depth estimator 132, or both. The efficiency metric 264 can thus indicate when one or both of the mono-image depth estimator 130 or the stereo-image depth estimator 132 are performing with higher or lower than expected accuracy (e.g., due to a particular type of scene for which the mono-image depth estimator 130 is more accurate than usual and/or the stereo-image depth estimator 132 is less accurate than usual, or vice-versa). The dynamic switch 120 can therefore adjust the threshold 320 to improve efficiency (e.g., accuracy per unit cost associated with computational load and/or power consumption), increase accuracy, or both.

In a particular embodiment, the scene detector 310 and the comparator 340 operating based on scene data of each set of frames in the time sequence of image frames 210, and optionally in conjunction with processing circuitry of the dynamic switch 120 associated with adjusting the threshold 320 based on the accuracy metric 262, the efficiency metric 264, or a combination thereof, functions as a classifier 390. The classifier 390 is configured to determine a classification that indicates a selection of the mono-image depth estimator 130 or the stereo-image depth estimator 132 for each incoming set of frames and based on one or more aspects of the scene data, the score 312, the threshold 320, or a combination thereof. In a particular embodiment, the classifier 390 is configured to determine the classification based on at least one of the accuracy metric 262 or the efficiency metric 264 associated with one or more previous depth estimates that correspond to one or more prior image frames of the time sequence of image frames 210.

During operation, the dynamic switch 120 routes the sets of image frames in the time sequence of image frames 210 according to comparisons of their respective scores 312 to the threshold 320. In the illustrated example, processing of the first set of frames 212 at the scene detector 310 results in a score 312 which is less than the threshold 320 and results in the comparator 340 generating an M indication as the selection signal 242. In response to the M indication, the router 230 sends the first routed image data 222 to the mono-image depth estimator 130. Processing of the second set of frames 214 at the scene detector 310 results in a score 312 which is greater than the threshold 320 and results in the comparator 340 generating an S indication as the selection signal 242. In response to the S indication, the router 230 sends the second routed image data 224, via the rectifier 128, to the stereo-image depth estimator 132. Processing of the third set of frames 216 at the scene detector 310 results in a score 312 which is less than the threshold 320 and results in the comparator 340 generating an M indication as the selection signal 242. In response to the M indication, the router 230 sends the third routed image data 226 to the mono-image depth estimator 130.

Optionally, the dynamic switch 120 can receive updated values of the accuracy metric 262, the efficiency metric 264, or both, as feedback from processing earlier frames of the time sequence of image frames 210 and may one or more adjustments to the threshold 320 for next sequential frames of the time sequence of image frames 210, such as to increase accuracy above a first threshold, to increase efficiency while allowing accuracy to decrease when the accuracy is above a second threshold, to make adjustments based on one or more values of the efficiency metric 264, or any combination thereof, as illustrative, non-limiting examples.

Although FIG. 3 depicts three sets of frames 212, 214, 216 in the time sequence of image frames 210, it should be understood that the time sequence of image frames 210 may have any number of sets of frames. Although the dynamic switch 120 is illustrated as receiving the accuracy metric 262 and the efficiency metric 264, in some embodiments the accuracy metric 262, the efficiency metric 264, or both are omitted, one or more other metrics of the historical depth estimation data 136 are received by the dynamic switch 120, or a combination thereof. Although the score 312 is described as a value within the range from 0 to 1, in other embodiments the score 312 may be in any other range of values or may be constrained to a discrete set of predetermined values (e.g., a quantized set of values).

FIG. 4 is a block diagram that depicts an example of aspects 400 of image data that can be used to select between mono-image depth estimation and stereo-image depth estimation, and detection mechanisms that can be used to determine various aspects 400, in accordance with one or more embodiments of the present disclosure. In some embodiments, one or more of the aspects 400 of FIG. 4 include or correspond to aspects of the image data 115, aspects of prior image data, one or more other aspects, or a combination thereof, upon which the criteria 122 of the device 102 of FIG. 1 is based.

The aspects 400 include one or more first aspects 402, one or more second aspects 404, and one or more other aspects 406. The first aspects 402 correspond to image data 115 that represents a scene and that is under evaluation for a mono-image depth estimation (e.g., for processing at the mono-image depth estimator 130) or for a stereo-image depth estimation (e.g., for processing at the stereo-image depth estimator 132).

In some embodiments, the first aspects 402 include complexity-related aspects, such as scene complexity 413, background complexity 415, and object complexity 417. To illustrate, a relatively large amount or variation of objects, colors, textures, fine details, occlusions, lighting conditions, etc. in an image corresponds to higher complexity, and a relatively small amount or variation of objects, colors, textures, fine details, occlusions, lighting conditions, etc. corresponds to lower complexity (i.e., “complexity” in this context refers to scene (or depth) complexity and is distinguished from “computational complexity” which refers to, e.g., an amount of computation, such as how many floating point operations are required and/or how much computation time or memory is required to compute a result). The scene complexity 413 can indicate an amount of complexity determined in the scene represented in the image data 115 and may be determined by a scene complexity detector 412. The background complexity 415 can indicate an amount of complexity detected in a background of the scene and may be determined by a background complexity detector 414. The object complexity 417 can indicate an amount of complexity detected in one or more objects in the scene and may be determined by an object complexity detector 416. In some embodiments, a complexity detector 410 includes one or more of the scene complexity detector 412, the background complexity detector 414, or the object complexity detector 416, or is configured to perform the function described for one or more of the scene complexity detector 412, the background complexity detector 414, or the background lighting detector 424, or any combination thereof.

In some examples, stereo-image depth estimation is more accurate for higher complexity images than mono-image depth estimation. As a result, in some embodiments, a classifier that outputs a selection of the mono-image depth estimator 130 or the stereo-image depth estimator 132 for each incoming set of frames may be biased toward selection of the stereo-image depth estimator 132 based on higher detected values of the scene complexity 413, the background complexity 415, the object complexity 417, or a combination thereof, and may be biased toward selection of the mono-image depth estimator 130 based on lower detected values of the scene complexity 413, the background complexity 415, the object complexity 417, or a combination thereof.

As used herein, a classifier being “biased toward” a particular result indicates that an internal state of the classifier is adjusted to increase a weighting toward that result (e.g., increasing a score for that result) but does not necessarily cause the classifier to output that result. For example, in a classifier that computes a first score for a first result and a second score for a second result and outputs the result having the highest score, one aspect that biases the classifier toward the first result may increase the first score but does not guarantee that the increased first score will be higher than the second score. Continuing this example, a second aspect that biases the classifier away from the first result may decrease the first score, a third aspect that biases the classifier toward the second result may increase the second score, and a fourth aspect that biases the classifier away from the second result may decrease the second score. Thus, the output of the classifier may be based on the combined (or net) effect of multiple aspects when determining whether to output the first result or the second result. The above example of a classifier that compares two scores after adjustments to select an output is provided for illustrative purposes and should not be considered limiting.

In some embodiments, the first aspects 402 include lighting-related aspects, such as scene lighting 423, background lighting 425, and object lighting 427, each of which may correspond to an amount of light, a light contrast (e.g., dynamic-range contrast), or both, of the scene, the background, or one or more objects in the scene, respectively. The scene lighting 423 can indicate an amount of light, light contrast, or both, determined in the scene represented in the image data 115 and may be determined by a scene lighting detector 422. The background lighting 425 can indicate an amount of light, light contrast, or both, detected in a background of the scene and may be determined by a background lighting detector 424. The object lighting 427 can indicate an amount of light, light contrast, or both, detected for one or more objects in the scene and may be determined by an object lighting detector 426. In some embodiments, a lighting detector 420 includes one or more of the scene lighting detector 422, the background lighting detector 424, or the object lighting detector 426 or is configured to perform the function described for one or more of the scene lighting detector 422, the background lighting detector 424, or the object lighting detector 426, or any combination thereof.

In some examples, stereo-image depth estimation is less accurate for low-light and/or low contrast conditions than mono-image depth estimation. As a result, in some embodiments, a classifier that outputs a selection of the mono-image depth estimator 130 or the stereo-image depth estimator 132 for each incoming set of frames may be biased toward selection of the stereo-image depth estimator 132 based on higher detected values of the scene lighting 423, the background lighting 425, the object lighting 427, or a combination thereof, and may be biased toward selection of the mono-image depth estimator 130 based on lower detected values of the scene lighting 423, the background lighting 425, the object lighting 427, or a combination thereof.

In some embodiments, the first aspects 402 include change-related aspects, such as scene change 433, background change 435, and object change 437, each of which may correspond to an amount of change detected in the scene, the background, or one or more objects in the scene, respectively, as compared to a previous set of the image data 115. The scene change 433 can indicate an amount of change determined for the scene represented in the image data 115 and may be determined by a scene change detector 432. The background change 435 can indicate an amount of change detected in a background of the scene and may be determined by a background change detector 434. The object change 437 can indicate an amount of change detected for one or more objects in the scene and may be determined by an object change detector 436. In some embodiments, a change detector 430 includes one or more of the scene change detector 432, the background change detector 434, or the object change detector 436 or is configured to perform the function described for one or more of the scene change detector 432, the background change detector 434, or the object change detector 436, or any combination thereof.

In some examples, although both stereo-image depth estimation and mono-image depth estimation for a sequence of image frames may have reduced accuracy when there are large changes from a prior image than for small changes, stereo-image depth estimation may be more likely to be accurate than mono-image depth estimation when there are large changes from a prior image. As a result, in some embodiments, a classifier that outputs a selection of the mono-image depth estimator 130 or the stereo-image depth estimator 132 for each incoming set of frames may be biased toward selection of the stereo-image depth estimator 132 based on higher detected values of the scene change 433, the background change 435, the object change 437, or a combination thereof. In some examples, the classifier may be biased toward selection of the mono-image depth estimator 130 based on lower detected values of the scene change 433, the background change 435, the object change 437, or a combination thereof.

In some embodiments, the first aspects 402 include movement-related aspects, such object movement 443, camera movement 445, and motion contrast 447, each of which may correspond to an amount of movement detected in one or more objects in the scene, an amount of movement of the cameras, or an amount of motion contrast in the scene, respectively, as compared to a previous set of the image data 115. The object movement 443 can indicate an amount and/or direction of movement (e.g., rigid motion (e.g., a rolling ball), non-rigid motion (e.g., a waving arm of a person), or both) of one or more objects of the scene represented in the image data 115 and may be determined by an object movement detector 442 (e.g., an object tracker). The camera movement 445 can indicate an amount of camera movement (e.g., rotation and/or translation of the image sensors 110 as a unit and/or individually, when independently actuated) and may be determined by a camera movement detector 444, e.g., based on inertial motion sensors of the device 102 and/or camera position data. The motion contrast 447 can indicate differences between the motions of one or more objects, regions, or other groups of pixels of the scene and may be determined by a motion contrast detector 446. In some embodiments, a movement detector 440 includes one or more of the object movement detector 442, the camera movement detector 444, or the motion contrast detector 446 or is configured to perform the function described for one or more of the scene the object movement detector 442, the camera movement detector 444, or the motion contrast detector 446, or any combination thereof.

In some examples, dynamic or moving scenes having motion blur, camera movement, or movement of objects in the scene can degrade the accuracy of stereo-image depth estimation, and may result in mono-image depth estimation being more accurate. As a result, in some embodiments, a classifier that outputs a selection of the mono-image depth estimator 130 or the stereo-image depth estimator 132 for each incoming set of frames may be biased away from selection of the stereo-image depth estimator 132 based on higher detected values of the object movement 443, the camera movement 445, the motion contrast 447, or a combination thereof.

The second aspects 404 correspond to previous image data of a scene and includes data resulting from performing mono-image depth estimation (e.g., at the mono-image depth estimator 130) or stereo-image depth estimation (e.g., at the stereo-image depth estimator 132) on the previous image data. In some embodiments, the second aspects 404 include a depth estimation 461, such as a depth map, or data associated with or derived from the depth map, such a depth complexity, a range of depth values, or an average depth value of the scene in the previous image data or across multiple previous images of the scene, or any combination thereof, as illustrative, non-limiting examples. In some embodiments, the second aspects 404 include a confidence value 463, such as one or more values indicating a reliability for the estimated depth value for each pixel of the depth map (e.g., a confidence map), an average confidence range for one or more regions of the depth map or for the entire depth map, or any combination thereof, as illustrative, non-limiting examples. In some embodiments, the second aspects 404 include a likelihood value 465, such as one or more values indicating a probability distribution of possible depth values and/or an uncertainty range of depth values, for each pixel of the depth map, a combined probability distribution or uncertainty range for one or more regions of the depth map or for the entire depth map, or any combination thereof, as illustrative, non-limiting examples.

In some examples, both stereo-image depth estimation and mono-image depth information may have increased accuracy when provided a depth map (e.g., the depth estimation 461) from a prior frame as compared to not having a depth map as an initial estimate for the current frame. In addition, stereo-image depth estimation can be more efficient (e.g., lower latency) when provided a depth map (e.g., a “warm start”) than when not provided a depth map (e.g., a “cold start”), in that a number of iterations to converge on disparity values can be reduced with an initial estimate in the form of a depth map from a prior frame. Aspects of the depth values within the depth estimation 461, such as object-based, region-based, or scene-based depth ranges or average values, can also indicate whether the current frame is likely to be more appropriately processed by stereo-image depth estimation or by mono-image depth estimation, in light of accuracy and efficiency effects of such aspects. The confidence value 463, the likelihood value 465, or both, indicating high accuracy of depth values can result in higher accuracy for mono-image depth estimation and both higher accuracy and higher efficiency (e.g., lower latency) for stereo-image depth estimation, as compared to such value(s) indicating low accuracy. As a result, in some embodiments, a classifier that outputs a selection of the mono-image depth estimator 130 or the stereo-image depth estimator 132 for each incoming set of frames may be biased toward selection of the stereo-image depth estimator 132 or the mono-image depth estimator 130 based on one or more of the above-described effects that can arise from the depth estimation 461, the confidence value 463, the likelihood value 465, or a combination thereof.

In some embodiments, the other aspects 406 include a camera overlap 471, such as a value indicating an amount of overlap of the fields of view of each of the cameras for the image data 115. To illustrate, the camera overlap 471 can indicate the extent that the left image 182A of FIG. 1 overlaps the right image 182B, the amount or proportion of the pixels in the left image data 115A that have a corresponding pixel in the right image data 115B, or a combination thereof. The camera overlap 471 can be based on physical data associated with each of the cameras, such as baseline, orientation, focal length, etc. of each camera at the time that an image was captured.

In some examples, a smaller amount of camera overlap impairs the accuracy of stereo-image depth estimation as compared to a larger amount of camera overlap, while the amount of camera overlap may not have significant effect on mono-image depth estimation, which processes a single image of the stereo pair of images. As a result, in some embodiments, a classifier that outputs a selection of the mono-image depth estimator 130 or the stereo-image depth estimator 132 for each incoming set of frames may be biased away from selection of the stereo-image depth estimator 132 based on lower values of the camera overlap 471, and may also be biased toward selection of the stereo-image depth estimator 132 based on higher values of the camera overlap 471.

Although various examples are described above to illustrate how each of the first aspects 402, the second aspects 404, and the other aspects 406 may influence the output of a mono-stereo classifier, such examples are for illustrative purposes only, and various embodiments of the mono-image depth estimator 130 or the stereo-image depth estimator 132 may exhibit different characteristics than described above. Further, although the effects of each of the first aspects 402, the second aspects 404, and the other aspects 406 can be individually determined and combined (e.g., using a weighted sum of normalized values), and the result compared to a threshold to generate a M or S classification for a given set of image frames, some combinations of the first aspects 402, the second aspects 404, and the other aspects 406 may result in interact in ways that are not reflected in linear combinations of the individual aspects'respective effects. Such combinations may be identified via testing and designed into decision logic of the classifier and/or incorporated into training data for ML versions of the classifier. In a particular example, end-to-end training of the classifier, the mono-image depth estimator 130, and/or the stereo-image depth estimator 132 may be performed (e.g., at the device 102 or at the remote device 190) to generate parameters for one or more models associated with the classifier, the mono-image depth estimator 130, the stereo-image depth estimator 132, or a combination thereof.

In a particular embodiment, the one or more criteria 122 of FIG. 1 are based on one or more of the first aspects 402 of the image data, one or more of the second aspects 404 of previous image data, or a combination thereof. In various embodiments, the criteria 122 can include or omit any combination of one or more of the first aspects 402, one or more of the second aspects 404, one or more of the other aspects 406, or any combination thereof. In a particular embodiment, the one or more first aspects 402 correspond to a complexity, a lighting, a light contrast, a change, or a combination thereof, of: the scene, an object in the scene, a background of the scene, or a combination thereof. In a particular embodiment, the one or more first aspects 402 correspond to a complexity of: the scene, an object in the scene, a background of the scene, or a combination thereof, such as may be determined by the complexity detector 410. In a particular embodiment, the one or more first aspects 402 correspond to a lighting or light contrast of: the scene, an object in the scene, a background of the scene, or a combination thereof, such as may be determined by the lighting detector 420. In a particular embodiment, the one or more first aspects 402 correspond to a change, relative to the previous image data, of: the scene, an object in the scene, a background of the scene, or a combination thereof, such as may be determined by the change detector 430. In a particular embodiment, the one or more first aspects 402 correspond to an object movement, a camera movement, a motion contrast, or a combination thereof, such as may be determined by the movement detector 440. In a particular embodiment, the second aspects 404 correspond to a depth estimation, a confidence value, a likelihood value, or a combination thereof, associated with the previous image data.

FIG. 5A is a block diagram of an example of components 500 that can be included in a depth estimation with mono-stereo switching system, in accordance with one or more aspects of the present disclosure. The components 500 include a classifier 502 that includes a scene detector 510, a comparator 540, and combination logic 530. The scene detector 510 includes a set of one or more detectors 504 and combination logic 506. In some embodiments, the components 500 of FIG. 5A include or correspond to components of the device 102 of FIG. 1. Each of components 500, or portion(s) thereof, may be implemented by a processor (e.g., the processor 108) executing instructions (e.g., software), dedicated hardware (e.g., circuitry), or a combination thereof.

The scene detector 510 is configured to receive the image data 115 and, in some embodiments, previous image data 516 that corresponds to a most recently processed previous set of the image data 115. The image data 115, the previous image data 516, or both, may be processed by each of the detectors 504, illustrated as a detector 504A, a detector 504B, a detector 504C. Each of the detectors 504 may correspond to one or more of the detectors of FIG. 4, such as the complexity detector 410, the scene complexity detector 412, the background complexity detector 414, the object complexity detector 416, the lighting detector 420, the scene lighting detector 422, the background lighting detector 424, the object lighting detector 426, the change detector 430, the scene change detector 432, the background change detector 434, the object change detector 436, the movement detector 440, the object movement detector 442, the camera movement detector 444, or the motion contrast detector 446. Although three detectors 504 are illustrated, in other embodiments, the scene detector 510 may include a single detector 504, two detectors 504, or more than three detectors 504.

Each of the detectors 504 generates a respective output that is provided as an input to combination logic 506. In an illustrative example, the output of each detector 504 corresponds to one of the first aspects 402 of FIG. 4. The combination logic 506 is configured to process the received inputs to generate a score 512, such as by generating a weighted sum of each of the inputs, as an illustrative, non-limiting example. In a particular embodiment, the score 512 corresponds to the score 312 of FIG. 3.

The combination logic 530 is configured to receive one or more inputs, such as the accuracy metric 262, the efficiency metric 264, the depth estimation 461, the confidence value 463, the likelihood value 465, or any combination thereof. Although the accuracy metric 262, the efficiency metric 264, the depth estimation 461, the confidence value 463, the likelihood value 465 are illustrated as inputs to the combination logic 530, in other embodiments one or more of the accuracy metric 262, the efficiency metric 264, the depth estimation 461, the confidence value 463, the likelihood value 465 may be omitted, one or more other inputs may be included, or both.

The combination logic 530 is configured to process the received inputs and, optionally, a default threshold 532, to generate a threshold 520. In a particular embodiment, the threshold 520 corresponds to the threshold 320 of FIG. 3. Although the combination logic 530 is illustrated as receiving the default threshold 532 and outputting the threshold 520, in other embodiments the combination logic 530 may instead output threshold adjustment data, and the comparator 540 may adjust the threshold 520 based on the received threshold adjustment data.

The comparator 540 is configured to output the selection signal 242 based on a comparison of the score 512 to the threshold 520. In an example, the comparator 540 outputs the M indicator based on the score 512 being less than or equal to the threshold 520, and outputs the S indicator based on the score 512 being greater than the threshold 520. In a particular embodiment, the comparator 540 corresponds to the comparator 340 of FIG. 3.

In a particular embodiment, the score 512 generated by the combination logic 506 is responsive to the outputs of the detectors 504 in a manner that accords with the effects of the respective first aspects 402, as described in FIG. 4. For example, the combination logic 506 may be configured to generate higher values of the score 512 based on outputs of one or more of the detectors 504 (e.g., one or more of the first aspects 402) that bias a selection decision toward stereo-image depth estimation and/or away from mono-image depth estimation, and to generate lower values of the score 512 based on outputs of one or more of the detectors 504 that bias the selection decision toward mono-image depth estimation and/or away from the stereo-image depth estimation.

Similarly, the threshold 520 generated by the combination logic 530 is responsive to accuracy metric 262 and the efficiency metric 264 in a manner that accords with the effects described previously with reference to FIG. 2 and FIG. 3, and is responsive to the depth estimation 461, the confidence value 463, and the likelihood value 465, in a manner that accords with the effects of the respective second aspects 404, as described in FIG. 4. For example, the combination logic 530 may be configured to generate lower values of the threshold 520 based on one or more inputs that bias a selection decision toward stereo-image depth estimation and/or away from mono-image depth estimation, and to generate higher values of the threshold 520 based on inputs that bias the selection decision toward mono-image depth estimation and/or away from the stereo-image depth estimation.

FIG. 5B is a block diagram of an example of components 550 that can be included in a depth estimation with mono-stereo switching system, in accordance with one or more aspects of the present disclosure. The components 550 include a classifier 552 that includes a selection model 554. In some embodiments, the components 550 of FIG. 5B include or correspond to components of the device 102 of FIG. 1. Each of components 550, or portion(s) thereof, may be implemented by a processor (e.g., the processor 108) executing instructions (e.g., software), dedicated hardware (e.g., circuitry), or a combination thereof.

The classifier 552 receives as inputs the image data 115, and may also receive one or more of the previous image data 516, the accuracy metric 262, the efficiency metric 264, the depth estimation 461, the confidence value 463, or the likelihood value 465, in a similar manner as described for the classifier 502 of FIG. 5A. The selection model 554 is configured to process the received inputs to generate the selection signal 242.

For example, the selection model 554 may be trained based on end-to-end training that also includes the mono-image depth estimator 130, the stereo-image depth estimator 132, or both. In a particular embodiment, each of the mono-image depth estimator 130, the stereo-image depth estimator 132, and the selection model 554 are individually trained, and then fine-tuning is performed using end-to-end training. In a particular embodiment, training may be based on a cost function configured to generate one or more sets of model parameters that are configured to cause the respective models to minimize depth estimation errors (or to achieve an acceptable depth estimation error rate) while also maximizing efficiency. Training may be performed on-device (e.g., at the device 102), or remotely (e.g., at the remote device 190), and the resulting model parameters may be transmitted to the end-user device (e.g., the device 102).

FIG. 5C is a block diagram of an example of components 570 that can be included in a depth estimation with mono-stereo switching system, in accordance with one or more aspects of the present disclosure. The components 570 include a classifier 572 that includes one or more of the detectors 504, one or more classifiers 576, and a selection model 574. In some embodiments, the components 570 of FIG. 5C include or correspond to components of the device 102 of FIG. 1. Each of components 570, or portion(s) thereof, may be implemented by a processor (e.g., the processor 108) executing instructions (e.g., software), dedicated hardware (e.g., circuitry), or a combination thereof.

The classifier 572 receives as inputs the image data 115, and may also receive one or more of the previous image data 516, the accuracy metric 262, the efficiency metric 264, the depth estimation 461, the confidence value 463, or the likelihood value 465, in a similar manner as described for the classifier 502 of FIG. 5A.

The image data 115, the previous image data 516, or both, may be processed by each of the detectors 504, illustrated as including six detectors 504A, 504B, 504C, 504D, 504E, and 504F. In a particular embodiment, each of the detectors 504 corresponds to one or more of the detectors of FIG. 4, and the output of each detector 504 corresponds to one of the first aspects 402 of FIG. 4. Although six detectors 504 are illustrated, in other embodiments, the classifier 572 may include any number of detectors 504, such as more than six detectors 504 or fewer than six detectors 504.

One or more of the detectors 504 may be configured to provide their respective outputs as inputs to the selection model 574. For example, the detectors 504A, 504B, and 504C provide output directly to the selection model 574. Outputs of the other detectors 504 are instead further processed, such as input to a corresponding classifier 576. For example, the detectors 504D, 504E, and 504F provide output to classifiers 576A, 576B, and 576C, respectively. Each of the classifiers 576 generates a classification output that is provided as an input to the selection model 574. For example, a classifier output can indicate whether the input to the classifier is above or below a particular threshold, or within one or more ranges of values, such as to determine whether the value of the corresponding first aspect 402 biases the classifier 572 toward or away from mono-image depth estimation, stereo-image depth estimation, or a combination thereof.

The selection model 574 receives as inputs outputs of the detectors 504A, 504B, and 504C, output of the classifiers 576A, 576B, and 576C, and may also receive one or more of the previous image data 516, the accuracy metric 262, the efficiency metric 264, the depth estimation 461, the confidence value 463, or the likelihood value 465, in a similar manner as described for the classifier 502 of FIG. 5A. The selection model 574 is configured to process the received inputs to generate the selection signal 242.

By processing the image data 115, the previous image data 516, or both, at the detectors 504, a computational load of the selection model 574 is reduced as compared to processing the image data 115 and the previous image data 516 at the selection model 554, such as in FIG. 5B. The classifiers 576 may further reduce the computational load of the selection model 574 by pre-processing the respective detector outputs prior to input to the selection model 574. In some embodiments, using individual detectors 504 and/or classifiers 576 enables modular updates to one or more of the components 570 without having to update the remaining components 570 including the selection model 574, reducing costs and development time associated with updating classifier 572.

FIG. 6 is a block diagram of an example of components 600 that can be included in a depth estimation with mono-stereo switching system, in accordance with one or more aspects of the present disclosure. The components 600 include the mono-image depth estimator 130, the stereo-image depth estimator 132, and the buffer 140 of FIG. 1. Each of components 600, or portion(s) thereof, may be implemented by a processor (e.g., the processor 108) executing instructions (e.g., software), dedicated hardware (e.g., circuitry), or a combination thereof.

In a particular embodiment, the processor 108 is configured to select whether to: perform joint depth estimation prediction based on the image data and the historical depth estimation data 136; or perform depth estimation prediction based on the image data without the historical depth estimation data 136. For example, the mono-image depth estimator 130 is configured to selectively perform joint depth estimation prediction based on receiving a mono-image depth estimation (MIDE) warm start signal 602. To illustrate, the MIDE warm start signal 602 having a first value (e.g., 1) may indicate that joint depth estimation prediction is to be performed based on the mono-image data 124 and using the historical depth estimation data 136, and the MIDE warm start signal 602 having a second value (e.g., 0) may indicate that depth estimation prediction is to be performed on the mono-image data 124 without using the historical depth estimation data 136, to generate the depth estimation data 134A.

As another example, the stereo-image depth estimator 132 is configured to selectively perform joint depth estimation prediction based on receiving a stereo-image depth estimation (SIDE) warm start signal 604. To illustrate, the SIDE warm start signal 604 having a first value (e.g., 1) may indicate that joint depth estimation prediction is to be performed based on the stereo-image data 126 and using the historical depth estimation data 136 (e.g., a warm start), and the SIDE warm start signal 604 having a second value (e.g., 0) may indicate that depth estimation prediction is to be performed on the stereo-image data 126 without using the historical depth estimation data 136 (e.g., a cold start), to generate the depth estimation data 134B.

In a particular embodiment, the processor 108 is configured to select between joint depth estimation prediction and non-joint depth estimation prediction based on an error propagation metric 606 associated with the historical depth estimation data 136. Because errors in the depth estimation data 134 for one set of image frames may propagate across successive sets of image frames due to the influence of the errors during joint depth estimation prediction, the error propagation metric 606 may be updated for each successive warm start depth estimation that is performed, and the updated error propagation metric 606 may be compared to a threshold to determine whether to use a warm start or cold start for the next set of image frames.

In a particular example, the error propagation metric 606 is a count of sequential warm starts, and the threshold is a maximum number of sequential warm starts that can be performed before performing a cold start to interrupt any errors that may be propagated via the historical depth estimation data 136. In other examples, the error propagation metric 606 and the threshold are determined based on one or more other factors. In some embodiments, separate error propagation metrics 606 may be used for the mono-image depth estimator 130 and the stereo-image depth estimator 132, respectively, based on the different error propagation characteristics that may be exhibited by the mono-image depth estimator 130 as compared to the stereo-image depth estimator 132.

Although both the mono-image depth estimator 130 and the stereo-image depth estimator 132 are illustrated as being configured to perform joint depth estimation prediction using the historical depth estimation data 136, in other embodiments, one or both of the mono-image depth estimator 130 or the stereo-image depth estimator 132 is not configured to perform joint depth estimation prediction using the historical depth estimation data 136.

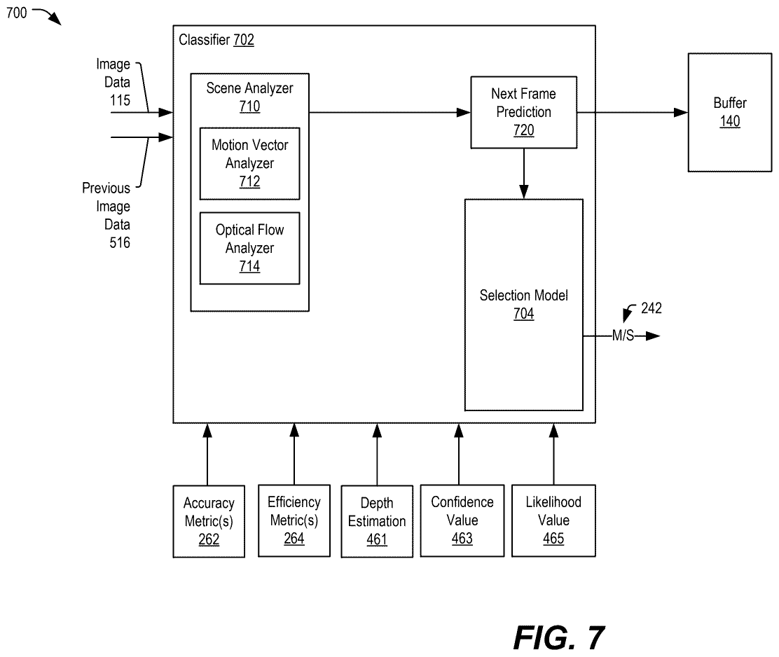

FIG. 7 is a block diagram of an example of components 700 that can be included in a depth estimation with mono-stereo switching system, in accordance with one or more aspects of the present disclosure. The components 700 include a classifier 702 and the buffer 140. The classifier 702 includes a scene analyzer 710 and a selection model 704. Each of components 700, or portion(s) thereof, may be implemented by a processor (e.g., the processor 108) executing instructions (e.g., software), dedicated hardware (e.g., circuitry), or a combination thereof.

The classifier 702 is configured to receive as input the image data 115 and, optionally, the previous image data 516. The scene analyzer 710 is configured to process the image data 115, the previous image data 516, or both, to generate a next frame prediction 720. For example, in a particular embodiment, the scene analyzer 710 includes a motion vector analyzer 712, an optical flow analyzer 714, one or more other analyzers configured to generate data associated with predicting a next image frame, or any combination thereof.

In a particular embodiment, the motion vector analyzer 712 is configured to process the image data 115, the previous image data 516, or both, to generate one or more motion vectors indicating a predicted movement of one or more pixel groups (e.g., pixel blocks, and/or one or more identified objects, features, scene elements, etc. that may be tracked from frame-to-frame by the scene analyzer 710) for the next frame prediction 720. For example, the motion vector analyzer 712 may identify a direction and magnitude of motion of one or more pixel groups of the image data 115 to predict (e.g., extrapolate) locations of the pixel groups in the next frame.

In a particular embodiment, the optical flow analyzer 714 is configured to process the image data 115, the previous image data 516, or both, to generate optical flow data indicating a predicted movement of pixels for the next frame prediction 720. For example, the optical flow analyzer 714 may identify a direction and magnitude of motion of one or more pixels of the image data 115 to predict (e.g., extrapolate) locations of the pixels in the next frame.

In a particular embodiment, a depth map from one or more prior frames (e.g., the depth estimation data 134 or the historical depth estimation data 136, such as included in the depth estimation 461) may be used to track movement of one or more groups of pixels in a depth direction (e.g., in a z-direction in a coordinate system in which the pixels of the image frame correspond to locations in an (x, y) image plane). For example, the motion vector analyzer 712, the optical flow analyzer 714, or both, may be supplemented with pixel depth predictions (e.g., of pixel blocks, objects, features, etc.) to generate predicted depth data for the next frame prediction 720.

The next frame prediction 720 may be provided as an input to the selection model 704, which may use one or more aspects of the next frame prediction 720, in conjunction with one or more of the image data 115, the previous image data 516, the accuracy metric 262, the efficiency metric 264, the object complexity detector 416, the confidence value 463, the likelihood value 465, or a combination thereof, to determine the selection signal 242. In a particular example, the classifier 702 also includes a scene detector, such as one or more of the detectors illustrated in FIG. 4, one or more components of the scene detector 510 of FIG. 5, or a combination thereof, to process the next frame prediction 720 to generate one or more inputs to the selection model 704.

In a particular embodiment, the next frame prediction 720 including predicted depth values is provided to the buffer 140 and may be used in conjunction with warm start depth estimation prediction at the mono-image depth estimator 130 or the stereo-image depth estimator 132. For example, the predicted depth values of the next frame prediction 720 may be a more accurate prediction for the current frame than the depth estimation data 134 of the prior frame, and may therefore result in more accurate depth estimates when used as an input for a joint depth estimation prediction.

In some embodiments, frame prediction may be deactivated based on one or more factors in order to reduce power consumption and computational load associated with generating the next frame prediction 720. For example, the classifier 702 may receive battery data of the device 102 and deactivate the scene analyzer 710 based on a battery level falling below a battery level threshold, to reduce power consumption associated with frame prediction and to extend the battery life of the device 102. As another example, the scene analyzer 710 may be deactivated when the current scene is relatively low-complexity, in which case the depth estimation data 134 generated for the prior frame may instead be used without significant loss of accuracy. In some embodiments, such as when the current scene is determined to be low-complexity, depth estimation processing may be bypassed entirely, and the depth estimation data 134 generated for the prior frame may also be used as the depth estimation for the current frame.

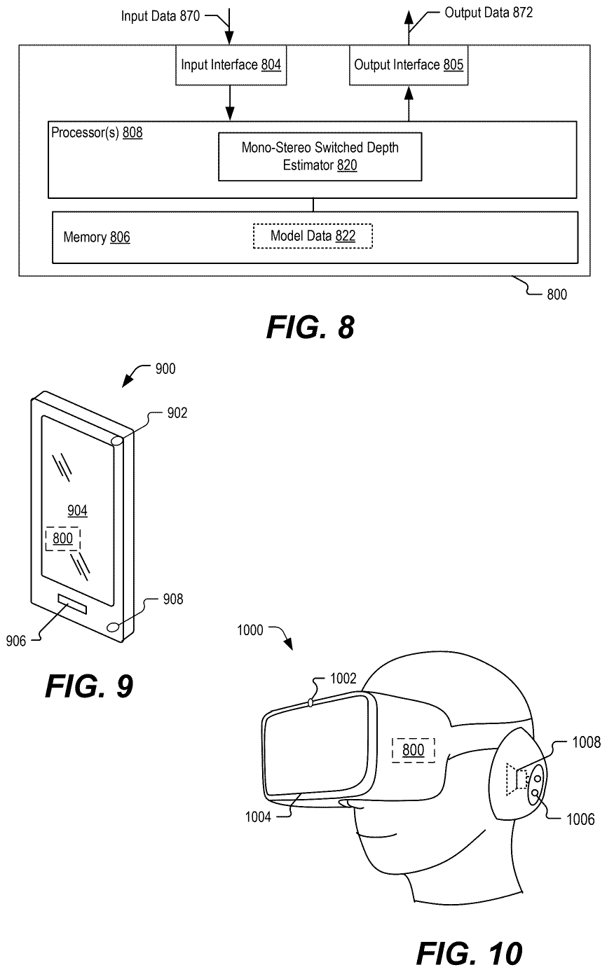

FIG. 8 depicts a diagram of an example of an integrated circuit 800 operable to perform multi-ROI processing by a trained model at inference-time, in accordance with some examples of the present disclosure. The integrated circuit 800 includes one or more processors 808 (herein after referred to as the “processor 808”) and a memory 806. The processor 808 and the memory 806 may include or correspond to the processor 108 and the memory 106, respectively. The processor 808 may include a mono-stereo switched depth estimator 820. The mono-stereo switched depth estimator 820 may include or correspond to the dynamic switch 120, the mono-image depth estimator 130, the 128, the stereo-image depth estimator 132, the buffer 140, the filter 138, the controller 170, one or more of the components 200, one or more of the components 300, one or more of the components 500, one or more of the components 550, one or more of the components 570, one or more of the components 600, one or more of the components 700, or a combination thereof. In some examples, the memory 806 includes (e.g., stores) model data 822, which may include or correspond to the model data 174.

The integrated circuit 800 also includes an input interface 804, such as one or more bus interfaces, to enable the integrated circuit 800 to receive input data 870 for processing. For example, the input data 870 can correspond to or include the sensor data 111, the image data 115, the time sequence of image frames 210, or a combination thereof. The integrated circuit 800 also includes an output interface 805, such as a bus interface, to enable the integrated circuit 800 to generate output data 872. For example, the output data 872 can correspond to or include the mono-image data 124, the stereo-image data 126, the depth estimation data 134, the control signal 160, the selection signal 242, or a combination thereof.

The integrated circuit 800 including the mono-stereo switched depth estimator 820 enables implementation of depth estimation with mono-stereo switching as a component in a system or a device. For example, the system or the device may include a mobile device (e.g., a mobile phone or tablet) as depicted in FIG. 9, a virtual reality, mixed reality, or augmented reality headset as depicted in FIG. 10, a wearable electronic device as depicted in FIG. 11, a voice-controlled speaker system as depicted in FIG. 12, a camera as depicted in FIG. 13, or a vehicle as depicted in FIG. 14.

In some embodiments, the system or the device that includes the integrated circuit 800 also includes or is coupled to an image sensor (e.g., a camera), an input device (e.g., a microphone, a keyboard or touch screen, etc.), a display device, a speaker, a modem, or a combination thereof. For example, the image sensor, the display device, the speaker, and the modem may include or correspond to the image sensors 110, the display device 116, the speaker 117, and the modem 118, respectively.

FIG. 9 depicts a diagram of a mobile device 900 operable to perform depth estimation with mono-stereo switching, in accordance with some examples of the present disclosure. The mobile device 900 may include or correspond to a phone or a tablet, as illustrative, non-limiting examples. The mobile device 900 includes a stereo camera 902 (e.g., a pair of image sensors), a display 904 (e.g., a display screen), a microphone 906, a speaker 908, and the integrated circuit 800. Components of the integrated circuit 800, including the mono-stereo switched depth estimator 820, are integrated in the mobile device 900 and are illustrated using dashed lines to indicate internal components that are not generally visible to a user of the mobile device 900.

In a particular example, the mono-stereo switched depth estimator 820 is operable to obtain image data representing images or video captured by the camera 902, from another device, or from an application executed by the mobile device 900, to generate depth estimation data for the images or videos, which may be used for one or more of XR, 3D modeling, or vehicular applications, as illustrative examples. Generation of a depth estimation using mono-stereo switching enables dynamic balancing between accuracy and efficiency in light of various aspects regarding the captured scene, historical depth estimation performance, or both.

FIG. 10 is a diagram of a headset 1000, such as a virtual reality, mixed reality, or augmented reality headset or glasses device, operable to perform depth estimation with mono-stereo switching, in accordance with some examples of the present disclosure. A visual interface device is positioned in front of the user's eyes to enable display of augmented reality, mixed reality, or virtual reality images or scenes to the user while the headset 1000 is worn. The headset 1000 also includes a stereo camera 1002 (e.g., stereo image sensors), a display 1004 (e.g., a display screen), a microphone 1006, a speaker 1008, and the integrated circuit 800. Components of the integrated circuit 800, including the mono-stereo switched depth estimator 820, are integrated in the headset 1000 and are illustrated using dashed lines to indicate internal components that are not generally visible to a user of the headset 1000.

In a particular example, the mono-stereo switched depth estimator 820 is operable to obtain image data representing images or video captured by the camera 1002, from another device, or from an application executed by the headset 1000, to generate depth estimation data for the images or videos, which may be used for one or more of XR, 3D modeling, or vehicular applications, as illustrative examples, such as to provide a 3D display in an AR, VR, or MR implementation of the headset 1000. Generation of a depth estimation using mono-stereo switching enables dynamic balancing between accuracy and efficiency in light of various aspects regarding the captured scene, historical depth estimation performance, or both.

FIG. 11 depicts a diagram of a wearable electronic device 1100 operable to perform depth estimation with mono-stereo switching, in accordance with some examples of the present disclosure. The wearable electronic device 1100 may include or correspond to a “smart watch,” as an illustrative, non-limiting example. The wearable electronic device 1100 includes a stereo camera 1102 (e.g., a pair of image sensors), a display 1104 (e.g., a display screen), a microphone 1106, a speaker 1108, and the integrated circuit 800. Components of the integrated circuit 800, including the mono-stereo switched depth estimator 820, are integrated in the wearable electronic device 1100 and are illustrated using dashed lines to indicate internal components that are not generally visible to a user of the wearable electronic device 1100.

In a particular example, the mono-stereo switched depth estimator 820 is operable to obtain image data representing images or video captured by the camera 1102, from another device, or from an application executed by the wearable electronic device 1100, to generate depth estimation data for the images or videos, which may be used for one or more of XR, 3D modeling, or vehicular applications, as illustrative examples. Generation of a depth estimation using mono-stereo switching enables dynamic balancing between accuracy and efficiency in light of various aspects regarding the captured scene, historical depth estimation performance, or both.

FIG. 12 is a diagram of a voice-controlled speaker system 1200 operable to perform depth estimation with mono-stereo switching, in accordance with some examples of the present disclosure. The voice-controlled speaker system 1200 may include or correspond to a wireless speaker and voice activated device, as an illustrative, non-limiting example. The voice-controlled speaker system 1200 can have wireless network connectivity and is configured to execute an assistant operation. The voice-controlled speaker system 1200 includes a stereo camera 1202 (e.g., a pair of image sensors), a display 1204 (e.g., a display screen), a microphone 1206, a speaker 1208, and the integrated circuit 800. Components of the integrated circuit 800, including the mono-stereo switched depth estimator 820, are integrated in the voice-controlled speaker system 1200 and are illustrated using dashed lines to indicate internal components that are not generally visible to a user of the voice-controlled speaker system 1200.

In a particular example, the mono-stereo switched depth estimator 820 is operable to obtain image data representing images or video captured by the camera 1202, from another device, or from an application executed by the voice-controlled speaker system 1200, to generate depth estimation data for the images or videos, which may be used for one or more of XR, 3D modeling, or vehicular applications, as illustrative examples. Generation of a depth estimation using mono-stereo switching enables dynamic balancing between accuracy and efficiency in light of various aspects regarding the captured scene, historical depth estimation performance, or both.

FIG. 13 is a diagram of a camera device 1300 operable to perform depth estimation with mono-stereo switching, in accordance with some examples of the present disclosure. The camera device 1300 includes stereo image sensors 1302, a display 1304 (e.g., a display screen), a microphone 1306, a speaker 1308, and the integrated circuit 800. Components of the integrated circuit 800, including the mono-stereo switched depth estimator 820, are integrated in the camera device 1300 and are illustrated using dashed lines to indicate internal components that are not generally visible to a user of the camera device 1300.

In a particular example, the mono-stereo switched depth estimator 820 is operable to obtain image data representing images or video captured by the image sensor 1302, from another device, or from an application executed by the camera device 1300, to generate depth estimation data for the images or videos, which may be used for one or more of XR, 3D modeling, or vehicular applications, as illustrative examples. Generation of a depth estimation using mono-stereo switching enables dynamic balancing between accuracy and efficiency in light of various aspects regarding the captured scene, historical depth estimation performance, or both.

FIG. 14 is a diagram of an example of a vehicle 1400 operable to perform depth estimation with mono-stereo switching, in accordance with some examples of the present disclosure. The vehicle 1400 may include or correspond to a car. The vehicle 1400 includes one or more stereo cameras 1402 (e.g., one or more pairs of outward-facing image sensors, one or more pairs of interior-facing image sensors, or a combination thereof), a display 1404 (e.g., a display screen), a microphone 1406, one or more speakers 1408, and the integrated circuit 800. Components of the integrated circuit 800, including the mono-stereo switched depth estimator 820, are integrated in the vehicle 1400 and are illustrated using dashed lines to indicate internal components that are not generally visible to a user of the vehicle 1400.

In a particular example, the mono-stereo switched depth estimator 820 is operable to obtain image data representing images or video captured by the camera 1402, from another device, or from an application executed by the vehicle 1400, to generate depth estimation data for the images or videos, which may be used for one or more of XR, 3D modeling, or vehicular applications, such as to generate the control signal 160 of FIG. 1 to control operation of the vehicle 1400 as part of, or in conjunction with, an autonomous control system or a driver assistance system for the vehicle 1400, such as a collision avoidance system of the vehicle 1400, as illustrative examples. Generation of a depth estimation using mono-stereo switching enables dynamic balancing between accuracy and efficiency in light of various aspects regarding the captured scene, historical depth estimation performance, or both.

According to an aspect, each of the embodiments of the systems or devices as described with reference to FIGS. 8-14 may correspond to, include, or be included in, the system 100 and/or the device 102 or FIG. 1. The embodiments of the systems or devices as described with reference to FIGS. 9-14 are described, respectively, as including a display, a microphone, a speaker, a stereo camera, or a combination thereof. As described with reference to FIGS. 9-14, the display, the speaker, and the stereo camera may include or correspond to the display device 116, the speaker 117, and the image sensors 110, respectively. It is noted that in other embodiments of the systems or devices of FIGS. 9-14, one or more of the systems or devices of FIGS. 9-14 may not include the display, the speaker, the stereo camera, or a combination thereof. Additionally, or alternatively, one or more of the systems or devices of FIGS. 9-14 may include an additional component. For example, the additional component may include a modem, such as the modem 118, or an input device, such as a microphone.

FIG. 15 is a diagram of an example of a method 1500 of performing depth estimation with mono-stereo switching, in accordance with some aspects of the present disclosure. In a particular aspect, one or more operations of the method 1500 are performed by the system 100, the device 102, the processor 108, the image capture unit 114, the dynamic switch 120, the mono-image depth estimator 130, the rectifier 128, the stereo-image depth estimator 132, the buffer 140, the filter 138, the controller 170, the components 200, the components 300, the components 500, the components 550, the components 570, the components 700, the integrated circuit 800, the mono-stereo switched depth estimator 820, the mobile device 900, the headset 1000, the wearable electronic device 1100, the voice-controlled speaker system 1200, the camera device 1300, the vehicle 1400, or a combination thereof.

In some embodiments, the method 1500 includes, at block 1502, obtaining, at one or more processors, image data based on one or more image capture operations of one or more cameras, the image data associated with a scene. For example, the processor 108 obtains the image data 115, such as based on the sensor data 111 from the image sensors 110.

The method 1500 also includes, at block 1504, switching, at the one or more processors, between a mono-image depth estimator and a stereo-image depth estimator based on one or more criteria associated with the image data. For example, the dynamic switch 120 switches between outputting the mono-image data 124 to the mono-image depth estimator 130 and outputting the stereo-image data 126 for processing at the stereo-image depth estimator 132.

In some embodiments, the image data is included in a time sequence of image frames from the one or more cameras, such as time sequence of image frames 210. In an example, the one or more criteria includes a selection schedule that indicates a sequence of depth estimators to be selected for generation of depth estimates that correspond to successive image frames of the time sequence of image frames, such as described with reference to the selection schedule 250.

In some embodiments, the method 1500 includes determining, based on the one or more criteria, a classification that indicates a selection of the mono-image depth estimator or the stereo-image depth estimator. For example, the classification may be generated by the classifier 390, the classifier 502, the classifier 552, or the classifier 572.

In some embodiments, the method 1500 includes selecting between: performing joint depth estimation prediction based on the image data and historical depth estimation data; or performing depth estimation prediction based on the image data without the historical depth estimation data. For example, as described with reference to FIG. 6, the processor 108 can select whether to perform warm start or cold start depth estimation prediction based the error propagation metric 606.

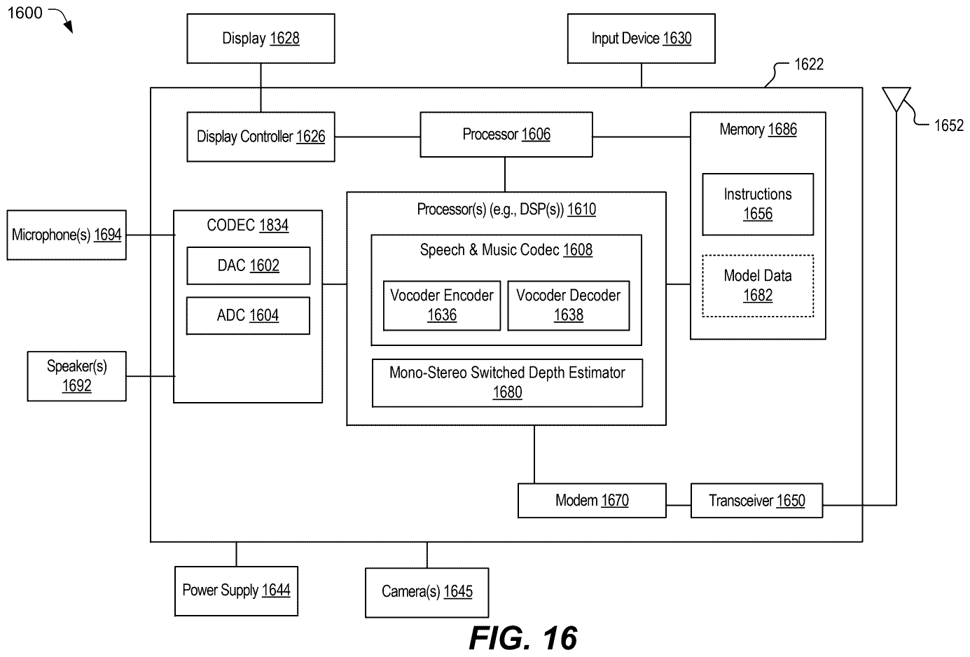

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by a processor that executes instructions, such as described with reference to FIG. 16.

It is noted that one or more blocks (or operations) described with reference to FIG. 15 may be combined with one or more blocks (or operations) described with reference to another of the figures. For example, one or more blocks associated with FIG. 15 may be combined with one or more blocks (or operations) associated with FIGS. 1-14. Additionally, or alternatively, one or more operations described above with reference to FIGS. 1-15 may be combined with one or more operations described with reference to FIG. 16.

FIG. 16 is a block diagram of an illustrative example of a device 1600 that is operable to perform depth estimation with mono-stereo switching, in accordance with one or more aspects of the present disclosure. In various implementations, the device 1600 may have more or fewer components than illustrated in FIG. 16. In an illustrative implementation, the device 1600 may correspond to the device 102. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor 108 of FIG. 1 or the processor 808 of FIG. 8 corresponds to the processor 1606, the processor(s) 1610, or a combination thereof. The processor(s) 1610 may include a speech and music coder-decoder (CODEC) 1608 that includes a voice coder (“vocoder”) encoder 1636, a vocoder decoder 1638, a mono-stereo switched depth estimator 1680, or a combination thereof. The mono-stereo switched depth estimator 1680 may include or correspond to the dynamic switch 120, the mono-image depth estimator 130, the rectifier 128, the mono-image depth estimator 130, the buffer 140, the filter 138, the controller 170, one or more of the components 200, one or more of the components 300, one or more of the components 500, one or more of the components 550, one or more of the components 570, one or more of the components 600, one or more of the components 700, the mono-stereo switched depth estimator 820, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1600 may include a memory 1686 and a CODEC 1634. The memory 1686 may include or correspond to the memory 106 or the memory 806. The memory 1686 may include instructions 1656, that are executable by the one or more additional processors 1610 (or the processor 1606) to implement the functionality described with reference to the mono-stereo switched depth estimator 1680. The instructions 1656 may include or correspond to the instructions 172. The memory 1686 optionally includes model data 1682. The model data 1682 may include or correspond to the model data 174 or the model data 822, and the model data 1682 may be used to implement the dynamic switch 120, the mono-image depth estimator 130, the rectifier 128, the stereo-image depth estimator 132, the filter 138, the controller 170, or any combination thereof. The device 1600 may include a modem 1670 coupled, via a transceiver 1650, to an antenna 1652.

The device 1600 may include a display 1628 coupled to a display controller 1626. One or more speakers 1692 and microphone(s) 1694 may be coupled to the CODEC 1634. The CODEC 1634 may include a digital-to-analog converter (DAC) 1602, an analog-to-digital converter (ADC) 1604, or both. In a particular implementation, the CODEC 1634 may receive analog signals from the microphone(s) 1694, convert the analog signals to digital signals using the ADC 1604, and provide the digital signals to the speech and music codec 1608. In a particular implementation, the speech and music codec 1608 may provide digital signals to the CODEC 1634. The CODEC 1634 may convert the digital signals to analog signals using the DAC 1602 and may provide the analog signals to the speaker(s) 1692.

In a particular implementation, the device 1600 may be included in a system-in-package or system-on-chip device 1622. In a particular implementation, the memory 1686, the processor 1606, the processor(s) 1610, the display controller 1626, the CODEC 1634, and the modem 1670 are included in the system-in-package or system-on-chip device 1622. In a particular implementation, an input device 1630, a power supply 1644, and a one or more cameras 1645 are coupled to the system-in-package or the system-on-chip device 1622. For example, the camera 1645 may include or correspond to the image sensors 110. In some examples, the input device 1630 may include or be associated with the display device 116 or the display 1628. Moreover, in a particular implementation, as illustrated in FIG. 16, the display 1628, the input device 1630, the speaker(s) 1692, the microphone(s) 1694, the antenna 1652, the power supply 1644, and the camera 1645 are external to the system-in-package or the system-on-chip device 1622. In a particular implementation, each of the display 1628, the input device 1630, the speaker(s) 1692, the microphone(s) 1694, the antenna 1652, the power supply 1644, and the camera 1645 may be coupled to a component of the system-in-package or the system-on-chip device 1622, such as an interface or a controller.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining image data based on one or more image capture operations of one or more cameras, the image data associated with a scene. For example, the means for obtaining the image data can include the image sensors 110, image capture unit 114, the dynamic switch 120, the processor 108, the device 102, the router 230, the scene detector 310, the classifier 390, the complexity detector 410, the scene complexity detector 412, the background complexity detector 414, the object complexity detector 416, the lighting detector 420, the scene lighting detector 422, the background lighting detector 424, the object lighting detector 426, the change detector 430, the scene change detector 432, the background change detector 434, the object change detector 436, the movement detector 440, the object movement detector 442, the camera movement detector 444, the object change detector 436, the scene detector 510, one or more of the detectors 504, the classifier 502, the classifier 552, the selection model 554, the classifier 572, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to obtain image data, or a combination thereof.

The apparatus also includes means for switching between a mono-image depth estimator and a stereo-image depth estimator based on one or more criteria associated with the image data. For example, the means for switching can the dynamic switch 120, the controller 170, the processor 108, the device 102, the router 230, the comparator 240, the classifier 290, the scene detector 310, the comparator 340, the classifier 390, the complexity detector 410, the scene complexity detector 412, the background complexity detector 414, the object complexity detector 416, the lighting detector 420, the scene lighting detector 422, the background lighting detector 424, the object lighting detector 426, the change detector 430, the scene change detector 432, the background change detector 434, the object change detector 436, the movement detector 440, the object movement detector 442, the camera movement detector 444, the object change detector 436, the scene detector 510, one or more of the detectors 504, the combination logic 506, the combination logic 530, the comparator 540, the classifier 502, the classifier 552, the selection model 554, the classifier 572, one or more of the classifiers 576, the selection model 574, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to obtain image data, or a combination thereof.

In some implementations, a non-transitory computer-readable medium (e.g., a computer-readable storage device, such as the memory 106 or the memory 1686) includes instructions (e.g., the instructions 172 or the instructions 1656) that, when executed by one or more processors (e.g., the processor 108, the processor(s) 1610, or the processor 1606), cause the one or more processors to obtain image data (e.g., the sensor data 111, the image data 115) based on one or more image capture operations of one or more cameras (e.g., the image sensors 110), the image data associated with a scene (e.g., the scene 180). The instructions, when executed by the one or more processors, also cause the one or more processors to switch between a mono-image depth estimator (e.g., the mono-image depth estimator 130) and a stereo-image depth estimator (e.g., the stereo-image depth estimator 132) based on one or more criteria (e.g., the criteria 122) associated with the image data.

Particular aspects of the disclosure are described below in sets of interrelated Examples:

According to Example 1, a device includes a memory configured to store image data associated with a scene; and one or more processors coupled to the memory and configured to obtain the image data based on one or more image capture operations of one or more cameras; and switch between a mono-image depth estimator and a stereo-image depth estimator based on one or more criteria associated with the image data.

Example 2 includes the device of Example 1, wherein the one or more processors are configured to select one of the mono-image depth estimator or the stereo-image depth estimator based on the one or more criteria, and wherein the one or more processors include a switch coupled to the mono-image depth estimator and the stereo-image depth estimator and configured to route the image data to the selected one of the mono-image depth estimator or the stereo-image depth estimator.

Example 3 includes the device of Example 1 or Example 2, wherein the selected one of the mono-image depth estimator or the stereo-image depth estimator is configured to process the image data to generate depth estimation data associated with the scene.

Example 4 includes the device of any of Examples 1 to 4, wherein the image data is included in a time sequence of image frames from the one or more cameras.

Example 5 includes the device of Example 4, wherein the one or more criteria includes a selection schedule that indicates a sequence of depth estimators to be selected for generation of depth estimates corresponding to successive image frames of the time sequence of image frames.

Example 6 includes the device of Example 5, wherein the one or more processors are configured to adjust the selection schedule based on at least one of an accuracy metric or an efficiency metric associated with one or more previous depth estimates that correspond to one or more prior image frames of the time sequence of image frames.

Example 7 includes the device of Example 4 or Example 5, wherein the one or more processors include a classifier configured to determine, based on the one or more criteria, a classification that indicates a selection of the mono-image depth estimator or the stereo-image depth estimator.

Example 8 includes the device of Example 7, wherein the classifier is configured to determine the classification based on at least one of an accuracy metric or an efficiency metric associated with one or more previous depth estimates that correspond to one or more prior image frames of the time sequence of image frames.

Example 9 includes the device of any of Examples 1 to 8, wherein the one or more criteria are based on one or more first aspects of the image data, one or more second aspects of previous image data, or a combination thereof.

Example 10 includes the device of Example 9, wherein the one or more first aspects correspond to a complexity, a lighting, a light contrast, a change, or a combination thereof, of: the scene, an object in the scene, a background of the scene, or a combination thereof.

Example 11 includes the device of Example 9, wherein the one or more first aspects correspond to a complexity of: the scene, an object in the scene, a background of the scene, or a combination thereof.

Example 12 includes the device of Example 9, wherein the one or more first aspects correspond to a lighting or light contrast of: the scene, an object in the scene, a background of the scene, or a combination thereof.

Example 13 includes the device of Example 9, wherein the one or more first aspects correspond to a change, relative to the previous image data, of: the scene, an object in the scene, a background of the scene, or a combination thereof.

Example 14 includes the device of Example 9, wherein the one or more first aspects correspond to an object movement, a camera movement, a motion contrast, or a combination thereof.

Example 15 includes the device of any of Examples 9 to 14, wherein the second aspects correspond to a depth estimation, a confidence value, a likelihood value, or a combination thereof, associated with the previous image data.

Example 16 includes the device of any of Examples 1 to 15 and further includes a buffer configured to store historical depth estimation data associated with at least one sequentially prior set of image data.

Example 17 includes the device of Example 16, wherein the one or more processors are configured to provide the historical depth estimation data and stereo image data from the image data as inputs to the stereo-image depth estimator.

Example 18 includes the device of Example 16 or Example 17, wherein the one or more processors are configured to select whether to: perform joint depth estimation prediction based on the image data and the historical depth estimation data; or perform depth estimation prediction based on the image data without the historical depth estimation data.

Example 19 includes the device of Example 18, wherein the one or more processors are configured to select between the joint depth estimation prediction and the depth estimation prediction based on an error propagation metric associated with the historical depth estimation data.

Example 20 includes the device of any of Examples 1 to 19, wherein the one or more processors include a rectifier configured to rectify the image data prior to input to the stereo-image depth estimator.

Example 21 includes the device of any of Examples 1 to 20, wherein the one or more processors are configured to generate, based on the image data and depth estimation data generated by the mono-image depth estimator or the stereo-image depth estimator, model data corresponding to a three-dimensional (3D) representation of the scene.

Example 22 includes the device of Example 21, further including a display device coupled to the one or more processors and configured to receive and display output data that is generated based on the model data and that corresponds to a view of the 3D representation of the scene.

Example 23 includes the device of Example 22, wherein the one or more processors and the display device are included in an extended reality headset.

Example 24 includes the device of Example 22, wherein the one or more processors and the display device are included in a laptop computer device, a mobile device, or a wearable device.

Example 25 includes the device of any of Examples 1 to 24, wherein the one or more processors are included in a vehicle and configured to generate, based on the image data and depth estimation data generated by the mono-image depth estimator or the stereo-image depth estimator, one or more control signals to control operation of the vehicle.

Example 26 includes the device of any of Examples 1 to 24, wherein the one or more processors are included in an integrated circuit.

Example 27 includes the device of any of Examples 1 to 26 and further includes the one or more cameras, wherein the one or more cameras are coupled to the one or more processors and configured to provide, to the one or more processors, camera sensor data corresponding to the image data.

Example 28 includes the device of any of Examples 1 to 27 and further includes a modem configured to receive the image data from a remote device.

According to Example 29, a method includes obtaining, at one or more processors, image data based on one or more image capture operations of one or more cameras, the image data associated with a scene; and switching, at the one or more processors, between a mono-image depth estimator and a stereo-image depth estimator based on one or more criteria associated with the image data.

Example 30 includes the method of Example 29, further comprising selecting one of the mono-image depth estimator or the stereo-image depth estimator based on the one or more criteria, and routing the image data to the selected one of the mono-image depth estimator or the stereo-image depth estimator.

Example 31 includes the method of Example 29 or Example 30, further comprising processing the image data to generate depth estimation data associated with the scene at the selected one of the mono-image depth estimator or the stereo-image depth estimator.

Example 32 includes the method of any of Examples 29 to 31, wherein the image data is included in a time sequence of image frames from the one or more cameras.

Example 33 includes the method of Example 32, wherein the one or more criteria includes a selection schedule that indicates a sequence of depth estimators to be selected for generation of depth estimates corresponding to successive image frames of the time sequence of image frames.

Example 34 includes the method of Example 33 and further includes adjusting the selection schedule based on at least one of an accuracy metric or an efficiency metric associated with one or more previous depth estimates that correspond to one or more prior image frames of the time sequence of image frames.

Example 35 includes the method of any of Examples 32 to 34 and further includes determining, based on the one or more criteria, a classification that indicates a selection of the mono-image depth estimator or the stereo-image depth estimator.

Example 36 includes the method of Example 35, wherein the determining the classification is based on at least one of an accuracy metric or an efficiency metric associated with one or more previous depth estimates that correspond to one or more prior image frames of the time sequence of image frames.

Example 37 includes the method of any of Examples 29 to 36, wherein the one or more criteria are based on one or more first aspects of the image data, one or more second aspects of previous image data, or a combination thereof.

Example 38 includes the method of Example 37, wherein the one or more first aspects correspond to a complexity, a lighting, a light contrast, a change, or a combination thereof, of: the scene, an object in the scene, a background of the scene, or a combination thereof.

Example 39 includes the method of Example 37, wherein the one or more first aspects correspond to a complexity of: the scene, an object in the scene, a background of the scene, or a combination thereof.

Example 40 includes the method of Example 37, wherein the one or more first aspects correspond to a lighting or light contrast of: the scene, an object in the scene, a background of the scene, or a combination thereof.

Example 41 includes the method of Example 37, wherein the one or more first aspects correspond to a change, relative to the previous image data, of: the scene, an object in the scene, a background of the scene, or a combination thereof.

Example 42 includes the method of Example 37, wherein the one or more first aspects correspond to an object movement, a camera movement, a motion contrast, or a combination thereof.

Example 43 includes the method of any of Examples 37 to 42, wherein the second aspects correspond to a depth estimation, a confidence value, a likelihood value, or a combination thereof, associated with the previous image data.

Example 44 includes the method of any of Examples 29 to 43 and further includes storing historical depth estimation data associated with at least one sequentially prior set of image data.

Example 45 includes the method of Example 44 and further includes providing the historical depth estimation data and stereo image data from the image data as inputs to the stereo-image depth estimator.

Example 46 includes the method of Example 44 or Example 45 and further includes selecting whether to: perform joint depth estimation prediction based on the image data and the historical depth estimation data; or perform depth estimation prediction based on the image data without the historical depth estimation data.

Example 47 includes the method of Example 46 and further includes selecting between the joint depth estimation prediction and the depth estimation prediction based on an error propagation metric associated with the historical depth estimation data.

Example 48 includes the method of any of Examples 29 to 47 and further includes rectifying the image data prior to input to the stereo-image depth estimator.

Example 49 includes the method of any of Examples 29 to 48 and further includes generating, based on the image data and depth estimation data generated by the mono-image depth estimator or the stereo-image depth estimator, model data corresponding to a three-dimensional (3D) representation of the scene.

Example 50 includes the method of Example 49 and further includes displaying output data that is generated based on the model data and that corresponds to a view of the 31D representation of the scene.

Example 51 includes the method of any of Examples 29 to 50, performed in an extended reality headset.

Example 52 includes the method of any of Examples 29 to 50, performed in a laptop computer method, a mobile device, or a wearable device.

Example 53 includes the method of any of Examples 29 to 52 and further includes generating, based on the image data and depth estimation data generated by the mono-image depth estimator or the stereo-image depth estimator, one or more control signals to control operation of a vehicle.

Example 54 includes the method of any of Examples 29 to 53 and further includes receiving camera sensor data corresponding to the image data.

Example 55 includes the method of any of Examples 29 to 54 and further includes receiving the image data from a remote device via a modem.

According to Example 56, a device includes a memory configured to store instructions; and a processor configured to execute the instructions to perform the method of any of Examples 29 to 55.

According to Example 57, a non-transitory computer readable storage medium that stores instructions that, when executed by a processor, cause the processor to perform the method of any of Examples 29 to 55.

According to Example 58, an apparatus includes means for carrying out the method of any of Examples 29 to 55.

According to Example 59, a non-transitory computer readable medium stores instructions that, when executed by one or more processors, cause the one or more processors to obtain image data based on one or more image capture operations of one or more cameras, the image data associated with a scene; and switch between a mono-image depth estimator and a stereo-image depth estimator based on one or more criteria associated with the image data.

According to Example 60, an apparatus includes means for obtaining image data based on one or more image capture operations of one or more cameras, the image data associated with a scene; and means for switching between a mono-image depth estimator and a stereo-image depth estimator based on one or more criteria associated with the image data.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store image data associated with a scene; and
one or more processors coupled to the memory and configured to:
obtain the image data based on one or more image capture operations of one or more cameras; and
switch between a mono-image depth estimator and a stereo-image depth estimator based on one or more criteria associated with the image data.

2. The device of claim 1, wherein the one or more processors are configured to select one of the mono-image depth estimator or the stereo-image depth estimator based on the one or more criteria, and wherein the one or more processors include a switch coupled to the mono-image depth estimator and the stereo-image depth estimator and configured to route the image data to the selected one of the mono-image depth estimator or the stereo-image depth estimator.

3. The device of claim 1, wherein the image data is included in a time sequence of image frames from the one or more cameras.

4. The device of claim 3, wherein the one or more criteria includes a selection schedule that indicates a sequence of depth estimators to be selected for generation of depth estimates corresponding to successive image frames of the time sequence of image frames.

5. The device of claim 3, wherein the one or more processors include a classifier configured to determine, based on the one or more criteria, a classification that indicates a selection of the mono-image depth estimator or the stereo-image depth estimator.

6. The device of claim 1, wherein the one or more criteria are based on one or more first aspects of the image data, one or more second aspects of previous image data, or a combination thereof.

7. The device of claim 6, wherein the one or more first aspects correspond to a complexity, a lighting, a light contrast, a change, or a combination thereof, of: the scene, an object in the scene, a background of the scene, or a combination thereof.

8. The device of claim 6, wherein the one or more first aspects correspond to an object movement, a camera movement, a motion contrast, or a combination thereof.

9. The device of claim 6, wherein the one or more second aspects correspond to a depth estimation, a confidence value, a likelihood value, or a combination thereof, associated with the previous image data.

10. The device of claim 1, further comprising a buffer configured to store historical depth estimation data associated with at least one sequentially prior set of image data.

11. The device of claim 10, wherein the one or more processors are configured to provide the historical depth estimation data and stereo image data from the image data as inputs to the stereo-image depth estimator.

12. The device of claim 10, wherein the one or more processors are configured to select whether to:
perform joint depth estimation prediction based on the image data and the historical depth estimation data; or
perform depth estimation prediction based on the image data without the historical depth estimation data.

13. The device of claim 1, wherein the one or more processors are configured to generate, based on the image data and depth estimation data generated by the mono-image depth estimator or the stereo-image depth estimator, model data corresponding to a three-dimensional (3D) representation of the scene.

14. The device of claim 13, further including a display device coupled to the one or more processors and configured to receive and display output data that is generated based on the model data and that corresponds to a view of the 3D representation of the scene.

15. The device of claim 14, wherein the one or more processors and the display device are included in an extended reality headset, a laptop computer device, a mobile device, or a wearable device.

16. The device of claim 1, wherein the one or more processors are included in a vehicle and configured to generate, based on the image data and depth estimation data generated by the mono-image depth estimator or the stereo-image depth estimator, one or more control signals to control operation of the vehicle.

17. The device of claim 1, further comprising the one or more cameras, wherein the one or more cameras are coupled to the one or more processors and configured to provide, to the one or more processors, camera sensor data corresponding to the image data.

18. The device of claim 1, further comprising a modem coupled to the one or more processors, the modem configured to receive the image data from a remote device.

19. A method comprising:
obtaining, at one or more processors, image data based on one or more image capture operations of one or more cameras, the image data associated with a scene; and
switching, at the one or more processors, between a mono-image depth estimator and a stereo-image depth estimator based on one or more criteria associated with the image data.

20. A non-transitory computer readable medium storing instructions that, when executed by one or more processors, cause the one or more processors to:
obtain image data based on one or more image capture operations of one or more cameras, the image data associated with a scene; and
switch between a mono-image depth estimator and a stereo-image depth estimator based on one or more criteria associated with the image data.
